(19) United States
(12) Patent Application Publication
(10) Pub. No.: US 2025/0006159 A1
(43) Pub. Date: Jan. 2, 2025

(54) CONTROL DEVICE, MUSICAL TONE GENERATION METHOD, AND COMPUTER READABLE RECORDING MEDIUM

(71) Applicant: Roland Corporation, Shizuoka (JP)

(72) Inventors: Shohei KUBO, Hamamatsu (JP); Shinji TOMITA, Hamamatsu (JP)

(73) Assignee: Roland Corporation, Shizuoka (JP)

(21) Appl. No.: 18/496,914

(22) Filed: Oct. 29, 2023

(30) Foreign Application Priority Data
Jun. 29, 2023 (JP) 2023-107076

(51) Int. Cl. G10H 1/00; G10H 1/34

(52) U.S. Cl. CPC G10H 1/0075; G10H 1/342; G10H 2210/225; G10H 2210/325

(57) ABSTRACT

A control device, a musical tone generation method, and a musical tone generation program capable of realizing fine change in pitch are provided.

In a synthesizer 1, when a tone generation mode is “string pitch bend”, pitch bend is set in an acquired MIDI message MM, and when a string number S of the MIDI message MM is generating a tone and a key-off flag is ON, a pitch of only a tone of the string number S is changed by a pitch change amount PB set in the MIDI message MM. This makes it possible to make fine pitch change in which strings of which pitches are changed on the basis of the pitch change amount PB and strings of which pitches are not changed are both included.

### CROSS-REFERENCE TO RELATED APPLICATION

This application claims the priority benefits of Japanese application no. 2023-107076, filed on Jun. 29, 2023. The entirety of the above-mentioned patent application is hereby incorporated by reference herein and made a part of this specification.

### BACKGROUND

### Technical Field

The disclosure relates to a control device, a musical tone generation method, and a computer readable recording medium that records a musical tone generation program.

### Description of Related Art

Non-Patent Document 1 discloses a guitar synthesizer (control device) that generates musical tones according to the vibration and pitch of each string of a connected guitar. A synthesizer 500 in FIG. 21, which is an example of such a synthesizer, includes analysis means 501a to 501f and tone generation means 502a to 502f. The analysis means 501a to 501f generate corresponding MIDI messages from vibration states of strings of a connected guitar G acquired from detection means 100a to 100f that acquire the vibration states of the strings. The tone generation means 502a to 502f output musical tones corresponding to the MIDI messages generated by the analysis means 501a to 501f, respectively, and the musical tones output from the tone generation means 502a to 502f are synthesized (added) and output from a speaker 19.

### Patent Documents

[Non-Patent Document 1] BOSS GP-10 Instruction Manual, [online], [Retrieved on Jun. 28, 2023], Internet <URL: https://static.roland.com/jp/media/pdf/GP-10_j02_W.pdf>

Here, there is a function called “pitch bend” of continuously changing a pitch of a tone being generated by a designated pitch change amount. In a synthesizer 500, when the pitch bend is executed, pitch change is instructed to all tone generation means 502a to 502f. Therefore, since all pitches of tones being generated change by executing the pitch bend, there is a problem that fine pitch change cannot be made and, for example, a musical tone for which strings of which pitches are changed through the pitch bend and strings of which pitches are not changed are both included cannot be generated.

### SUMMARY

The disclosure has been made to solve the above-described problem, and provides a control device, a musical tone generation method, and a computer readable recording medium that records a musical tone generation program capable of realizing fine change in pitch.

To achieve this object, a control device of the present invention includes: an acquisition part configured to acquire performance information; a tone generation control part configured to generate a musical tone based on the performance information acquired by the acquisition part; a change amount acquisition part configured to acquire a pitch change amount that is a change amount by which a pitch is changed; a changing string number acquisition part configured to acquire a string number of a string of a stringed instrument that is a pitch change target; and a pitch changing part configured to change a pitch of the musical tone generated by the tone generation control part corresponding to the string number acquired by the changing string number acquisition part, on the basis of the pitch change amount acquired by the change amount acquisition part.

A musical tone generation method of the present invention includes: an acquisition step of acquiring performance information; a tone generation control step of generating a musical tone based on the performance information acquired in the acquisition step; a change amount acquisition step of acquiring a pitch change amount that is a change amount by which a pitch is changed; a changing string number acquisition step of acquiring a string number of a string of a stringed instrument that is a pitch change target; and a pitch changing step of changing a pitch of the musical tone generated in the tone generation control step corresponding to the string acquired in the changing string number acquisition step, on the basis of the pitch change amount acquired in the change amount acquisition step.

Further, a computer readable recording medium that records a musical tone generation program of the present invention is a program for causing a computer to execute musical tone generation processing, the musical tone generation program causing the computer to execute: an acquisition step of acquiring performance information; a tone generation control step of generating a musical tone based on the performance information acquired in the acquisition step; a change amount acquisition step of acquiring a pitch change amount that is a change amount by which a pitch is changed; a changing string number acquisition step of acquiring a string number of a string of a stringed instrument that is a pitch change target; and a pitch changing step of changing a pitch of the musical tone generated in the tone generation control step corresponding to the string acquired in the changing string number acquisition step, on the basis of the pitch change amount acquired in the change amount acquisition step.

### BRIEF DESCRIPTION OF THE DRAWINGS

FIG. 1A is a block diagram illustrating an electrical configuration of a synthesizer, FIG. 1B is a diagram schematically illustrating a string map, and FIG. 1C is a diagram schematically illustrating a pitch map.

FIG. 2A is a functional block diagram of the synthesizer, and FIG. 2B and FIG. 2C schematically show a structure of a MIDI message.

FIG. 3 is a flowchart of GT analysis processing.

FIG. 4 is a flowchart of packet creation processing.

FIG. 5A is a flowchart of MIDI processing, and FIG. 5B is a flowchart of acquisition processing.

FIG. 6A is a diagram illustrating a string mono in a tone generation mode, and FIG. 6B is a flowchart of tone generation processing in the string mono.

FIG. 7A is a diagram illustrating mono of the tone generation mode, FIG. 7B is a diagram illustrating mono retrigger of the tone generation mode, and FIG. 7C is a diagram illustrating string mono retrigger of the tone generation mode.

FIG. 8A is a flowchart of tone generation processing in mono mono retrigger, and string mono retrigger, FIG. 8B is a flowchart of note-on processing, and FIG. 8C is a flowchart of note-off processing.

FIG. 9 is a flowchart of tone generation processing in string pitch bend.

FIG. 10A is a flowchart of tone generation processing in string legato, and FIG. 10B is a flowchart of legato preprocessing.

FIG. 11 is a diagram illustrating string mono & hold normal.

FIG. 12 is a diagram illustrating string mono & hold keep.

FIG. 13 is a diagram illustrating string mono & hold string.

FIG. 14 is a diagram illustrating string mono and sostenuto.

FIG. 15 is a functional block diagram of a synthesizer according to a second embodiment.

FIG. 16A to FIG. 16C are diagrams illustrating string pitch bend in a tone generation mode using the synthesizer of the second embodiment.

FIG. 17 is a block diagram illustrating an electrical configuration of a synthesizer according to a third embodiment.

FIG. 18 is a functional block diagram of the synthesizer according to the third embodiment.

FIG. 19A to FIG. 19C are diagrams each schematically illustrating a structure of a MIDI message according to the third embodiment.

FIG. 20 is a flowchart of acquisition processing according to the third embodiment.

### DESCRIPTION OF THE EMBODIMENTS

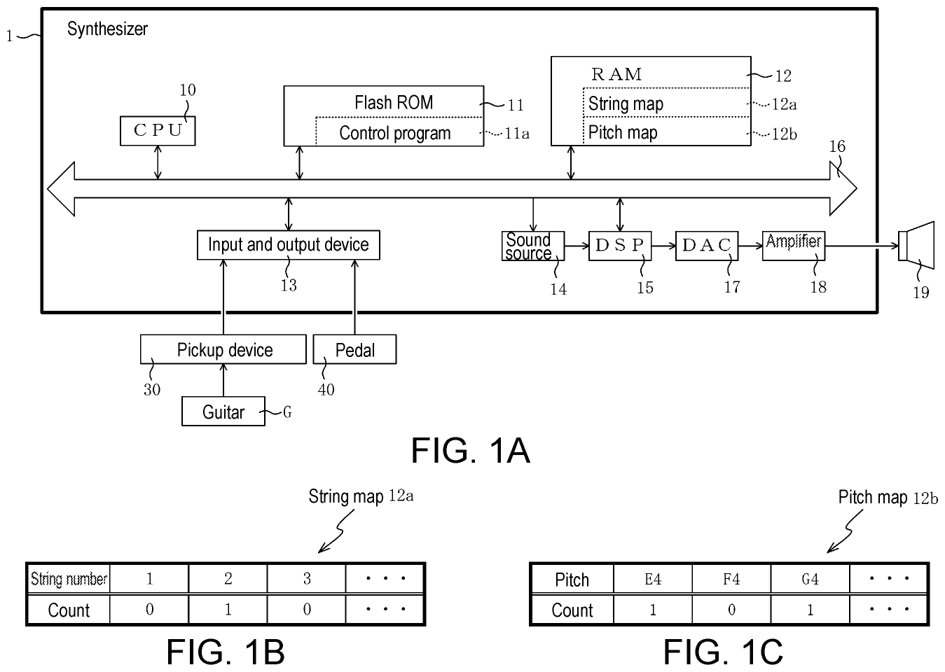

Hereinafter, preferred embodiments will be described with reference to the accompanying drawings. First, an electrical configuration of a synthesizer 1 of the present embodiment will be described with reference to FIG. 1A. FIG. 1A is a block diagram illustrating the electrical configuration of the synthesizer 1. The synthesizer 1 is an electronic musical instrument (control device) that outputs musical tones according to a performance input from a connected guitar G (stringed instrument). The synthesizer 1 includes a CPU 10, a flash ROM 11, a RAM 12, an input and output device 13, a sound source 14, and a digital signal processor 15 (hereinafter referred to as a “DSP 15”), which are connected to each other via a bus line 16.

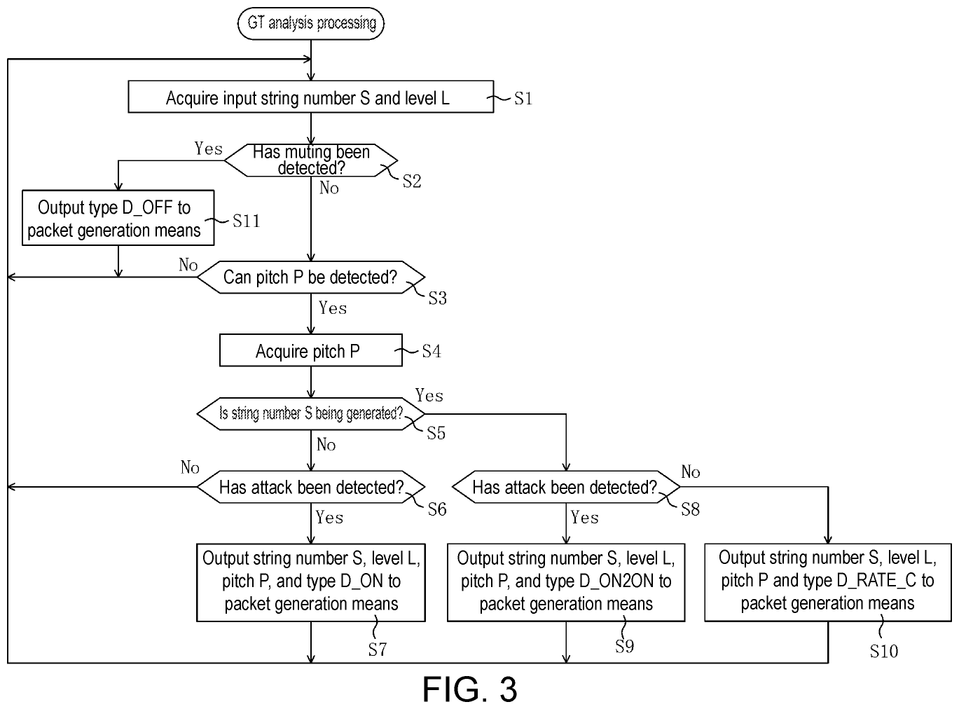

The CPU 10 is a computing device that controls each unit connected by the bus line 16. The flash ROM 11 is a rewritable nonvolatile storage device that stores programs executed by the CPU 10, fixed value data, and the like, and includes a control program 11a. When the control program 11a is executed by the CPU 10, GT analysis processing illustrated in FIG. 3 and the like are executed. The RAM 12 is a memory for rewritably storing various types of work data, flags, and the like when the CPU 10 executes a program, and is provided with a string map 12a and a pitch map 12b. The string map 12a and the pitch map 12b will be described with reference to (b) and FIG. 1C.

FIG. 1B is a diagram schematically illustrating the string map 12a, and FIG. 1C is a diagram schematically illustrating the pitch map 12b. The string map 12a is a data table for managing, for each string number S of the string of the guitar G, whether the corresponding string is subjected to note-on. In the string map 12a, when a determination is made that the string of the guitar G is operated by the user H and the note-on is performed, 1 is added to the count corresponding to the string number S of the string subjected to the note-on. On the other hand, when a determination is made that the string of the guitar G is operated by the user H and subjected to note-off, 1 is subtracted from the count corresponding to the string number S of the note-off string.

Further, the pitch map 12b is a data table for managing, for each pitch P, whether a corresponding pitch is subjected to note-on. When the strings of the guitar G are operated by the user H and a determination is made that note-on has been made, 1 is added to a count corresponding to the pitch P of a note-on musical tone. On the other hand, when the strings of the guitar G are operated by the user H and a determination is made that the note-off is instructed, 1 is subtracted from the count corresponding to the pitch of the note-off musical tone. The synthesizer 1 determines with which pitch P with which string number S the musical tone is subjected to note-on using the string map 12a and the pitch map 12b.

Returning to FIG. 1A, the input and output device 13 is a device that receives information from an external device and outputs information to the external device. A pickup device 30 and a foot pedal 40 are connected to the input and output device 13 as external devices. The pickup device 30 is a device to which the guitar G is connected and that acquires a state of the vibration of each string of the guitar G. The pedal 40 of the present embodiment is provided with a hold pedal and a sostenuto pedal (both not illustrated), but may include other pedals. The synthesizer 1 generates and outputs a musical tone on the basis of information from the pickup device 30 and the pedal 40 connected to the input and output device 13.

The sound source 14 is a device that outputs waveform data based on performance information input from the CPU 10. The DSP 15 is a computing device for performing calculation processing on the waveform data input from the sound source 14. A digital-to-analog converter (DAC) 17 is connected to the DSP 15, an amplifier 18 is connected to the DAC 17, and a speaker 19 is connected to the amplifier 18.

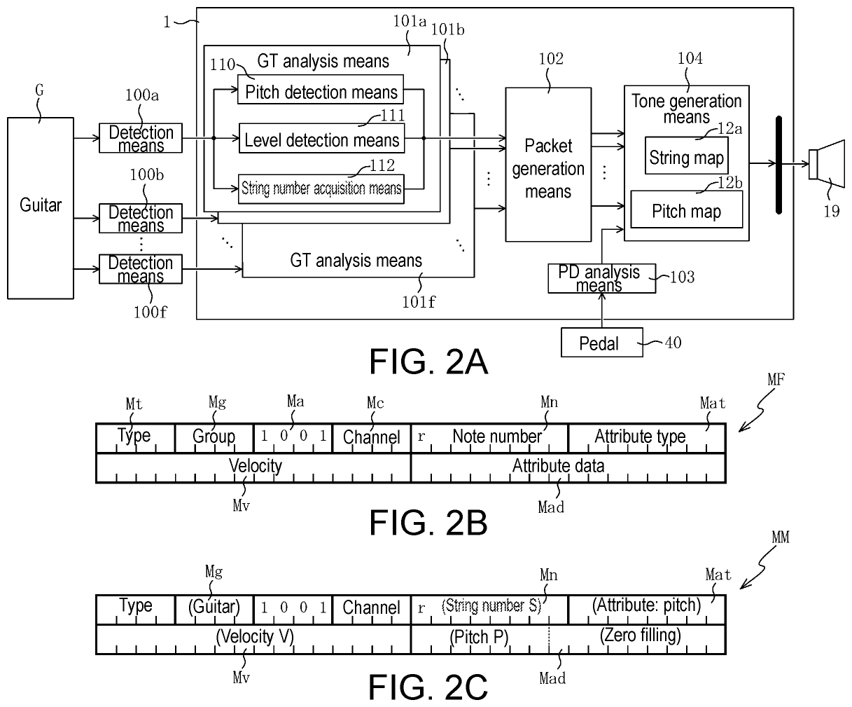

Next, functions of the synthesizer 1 will be described with reference to FIG. 2. FIG. 2A is a functional block diagram of the synthesizer 1. The synthesizer 1 includes GT analysis means 101a to 101f, a packet generation means 102, a PD analysis means 103, and a tone generation means 104.

The GT analysis means 101a to 101f each analyze the pitch P, level L, and the like from the acquired state of the vibration of the string of the guitar G, and are realized by the CPU 10 described above. The state of the vibration of the strings of the guitar G acquired by the GT analysis means 101a to 101f is acquired by the detection means 100a to 100f provided for the respective strings of the guitar G. The detection means 100a to 100f are realized by the pickup device 30 described above. In the present embodiment, since the guitar G has six strings, the detection means 100a to 100f corresponding to the respective strings are provided. The number of strings of the guitar G is not limited to six, and may be six or more or six or less. In this case, the detection means and the GT analysis means may be provided in a number corresponding to the number of strings of the guitar G.

A pitch detection means 110 that detects the pitch P from the state of the vibration of the corresponding string, a level detection means 111 that detects the level L from the state of the vibration of the corresponding string, and a string number acquisition means 112 that acquires the string number S of the corresponding string are provided in each of the GT analysis means 101a to 101f.

As a scheme for detecting the pitch P in the pitch detection means 110 or a scheme for detecting the level L in the level detection means 111, known schemes are used. Further, an example of a scheme for acquiring the string number S in the string number acquisition means 112 includes a scheme for acquiring the string number S of the strings of the guitar G assigned to the corresponding detection means 100a to 100f in advance, but the string number S may be acquired using other schemes. Each of the GT analysis means 101a to 101f can acquire an independent pitch P, level L, and string number S for each string of the guitar G. The pitch P, level L, and string number S detected and acquired by each of the GT analysis means 101a to 101f are input to the packet generation means 102.

The packet generation means 102 generates a musical instrument digital interface (MIDI) message MM, which is performance information in which information on various performances based on the pitch P, level L, and string number S input from the detection means 100a to 100f has been set. The MIDI message MM of the present embodiment conforms to a “MIDI 2.0” standard. A structure of the MIDI message MM and a MIDI message MF which is a format of the MIDI message MM will be described with reference to FIG. 2B and FIG. 2C.

FIG. 2B and FIG. 2C are diagrams schematically illustrating structures of the MIDI messages MF and MM, respectively. The MIDI message MF used as the format of the MIDI message MM conforms to the “MIDI 2.0” standard. In the case of the note-off or note-on, areas of a type Mt, a group Mg, a message type Ma, a channel Mc, a note number Mn, an attribute type Mat, a velocity Mv, and attribute data Mad are provided as illustrated in FIG. 2B and FIG. 2C.

Further, in the case of string pitch bend in which each string is pitch bend, the area of the attribute type Mat in FIG. 2B and FIG. 2C is omitted, and a pitch change amount Mp is provided (not illustrated) instead of the velocity Mv and the attribute data Mad in FIG. 2B and FIG. 2C.

In the message type Ma, performance instructions in MIDI such as note-on and note-off is stored as corresponding values. Since it is shown that the MIDI messages MF and MM in FIG. 2B and FIG. 2C are messages at the time of note-on, “1001” which is a value indicating note-on is stored in the message type Ma. In addition, in the message type Ma, “1000” is stored in the case of the note-off, and “0110” is stored in the case of string pitch bend. A message in which information on the performance created by the packet generation means 102 is stored in such a MIDI message MF is the MIDI message MM.

As illustrated in FIG. 2C, in the MIDI message MM created by the packet generation means 102, information indicating “guitar” indicating being on the performance of the guitar G is stored in the group Mg. “Attribute: Pitch” indicating that pitch information is stored in the attribute data Mad is stored in the attribute type Mat. Further, the string number S acquired from the GT analysis means 101a to 101f is stored in the note number Mn, the velocity V based on the level L acquired from the GT analysis means 101a to 101f is stored in the velocity Mv, and the pitch P acquired from the GT analysis means 101a to 101f are stored in the attribute data Mad.

Although not illustrated, in the case of the note-off, “1000” is stored in the message type Ma, and the information indicating “guitar” is stored in the group Mg, “attribute: pitch” in the attribute type Mat, the string number S in the note number Mn, and the velocity V in the velocity Mv as in the case of the note-on. Further, in the case of “string pitch bend” in which the pitch bend is performed on each string, “0110” is stored in the message type Ma, the information indicating “guitar” in the group Mg, the string number S in the note number Mn, and a pitch change amount PB which is an amount of change in pitch at the time of pitch bending in the pitch change amount Mp.

The MIDI message MM created in this way is input to the tone generation means 104 and used for generation of the musical tone. The MIDI message MM is not limited to one compliant with the “MIDI 2.0” standard, but may be one compliant with other standards such as “MIDI 1.0”.

Return to FIG. 2A. The PD analysis means 103 creates a control change message based on information input from the pedal 40. The tone generation means 104 generates the musical tone based on the input MIDI message MM, and is realized by the CPU 10, the above-described string map 12a and pitch map 12b, the sound source 14, the DSP 15, the DAC 17, and the amplifier 18. In the present embodiment, since only one tone generation means 104 is provided, the number of tone generation means 104 smaller than the number of strings (six) of the connected guitar G is provided.

Specifically, when an instruction to perform the MIDI message MM input from the packet generation means 102 is note-on, the tone generation means 104 adds “1” to the counts corresponding to the string number S and the pitch P of the MIDI message MM in the string map 12a and the pitch map 12b. On the other hand, when the performance instruction is the note-off, the tone generation means 104 subtracts “1” from the counts corresponding to the string number S and the pitch P of the MIDI message MM in the string map 12a and the pitch map 12b.

A musical tone corresponding to the pitch P and velocity V of the MIDI message MM input from the packet generation means 102 or the like, the note-on, the note-off, or the like is output, and is emitted from the speaker 19. In this case, the output of musical tone is controlled on the basis of a state of the count of the string map 12a and the pitch map 12b.

As described above, the MIDI message MM is generated by the packet generation means 102 on the basis of the pitch P, level L, and string number S detected and acquired by the GT analysis means 101a to 101f each provided for the detection means 100a to 100f, that is, for the strings of the guitar G, and is input to the tone generation means 104. The tone generation means 104 outputs a musical tone according to the pitch P and velocity V of the MIDI message MM input from the packet generation means 102 and a performance instruction such as the note-on or the note-off. This makes it possible to output a musical tone based on the MIDI message MM input from a plurality of strings of the guitar G using one tone generation means 104.

Here, in the synthesizer 500 of the related art illustrated in FIG. 21, analysis means 501a to 501f that create a MIDI message MM on the basis of the pitch P and the level L detected by the detection means 100a to 100f are provided for each of the detection means 100a to 100f, and tone generation means 502a to 502f that perform tone generation of the created MIDI message MM are provided in each of the analysis means 501a to 501f.

That is, in the synthesizer 500 of the related art, the tone generation means 502a to 502f are provided for each string of the guitar G. This makes it possible to realize accurate generation and muting of the musical tones for each string of the guitar G. On the other hand, however, since constituting the tone generation means requires resources regarding the processing of the synthesizer 500, six tone generation means 502a to 502f are provided and this causes a heavy processing load on the synthesizer 500.

Therefore, in the synthesizer 1 of the present embodiment, a musical tone generation state or a non-musical tone generation state is managed for each string number S and pitch P by using the string map 12a and the pitch map 12b of the tone generation means 104, making it possible to realize accurate generation and muting of the musical tones for each string of the guitar G even when the tone generation means 104 is not provided in each string of the guitar G, that is, even when the number of tone generation means 104 is smaller than the number of strings of the guitar G. This makes it possible to reduce a processing load required for the tone generation means 104 in the synthesizer 1.

Next, processing that is executed by the GT analysis means 101a to 101f, the packet generation means 102, and the tone generation means 104 will be described with reference to FIGS. 3 to 14. First, the processing that is executed by the GT analysis means 101a to 101f will be described with reference to FIG. 3. FIG. 3 is a flowchart of the GT analysis processing. The GT analysis processing is a processing that is executed independently by each of the GT analysis means 101a to 101f after the synthesizer 1 is powered on.

In the GT analysis processing, first, the level L corresponding to the state of the vibration input from the corresponding detection means 100a to 100f and the string number S assigned to the corresponding detection means 100a to 100f are acquired (S1).

After the processing of S1, a confirmation is made as to whether or not muting has been detected on the basis of the acquired level L (S2). In the processing of S2, for example, when the level L acquired in the processing of S1 is lower than a predetermined threshold value, this is detected as muting, but the muting may be detected by other schemes.

When the muting is not detected in the processing of S2 (S2: No), a confirmation is made as to whether or not the pitch P can be detected from the state of the vibration input from the corresponding detection means 100a to 100f (S3). When the pitch P can be detected in the processing of S3 (S3: Yes), the detected pitch P is acquired (S4).

After the processing of S4, a confirmation is made as to whether or not the string with the string number S assigned to the corresponding detection means 100a to 100f is generating a tone (S5). In the processing of S5, for example, when the type D_ON (described below) of the corresponding string number S is output in previous GT analysis processing, and then, a determination is made that the tone is being generated when a type D_OFF (described below) is not output, a detection may be made as to whether the tone is being generated using other schemes.

When the string with the corresponding string number S is not generating a tone in the processing of S5 (S5: No), a confirmation is further made whether or not an attack has been detected (S6). In the processing of S6, for example, the attack may be detected on the basis of the change in level L (more specifically, an amplification factor) acquired in the processing of S1, but the attack may be detected using other schemes.

When the attack has been detected in the processing of S6 (S6: Yes), the string number S and the level L acquired in the processing of S1, the pitch P acquired in the processing of S4, and the type D_ON indicating the note-on are output to the packet generation means 102 (S7).

When the corresponding string with the string number S is generating the tone in the processing of S5 (S5: Yes), a confirmation is further made whether or not an attack has been detected (S8). In the processing of S8, the detection of the attack is confirmed using the same scheme as in S6 described above. When the attack is detected in the processing of S8 (S8: Yes), the string number S and the level L acquired in the processing of S1, the pitch P acquired in the processing of S4, and a type D_ON2ON indicating that note-on has further been performed on a currently note-on string are output to the packet generation means 102 (S9).

When the attack is not detected in the processing of S8 (S8: No), the string number S and the level L acquired in the processing of S1, the pitch P acquired in the processing of S4, and a type D_RATE_C indicating that the pitch P has changed by performing sliding, choking, vibrato, or the like (hereinafter referred to as “sliding or the like”) on the corresponding string are output to the packet generation means 102 (S10). Further, when the silence has been detected in the processing of S2 (S2: Yes), the type D_OFF indicating note-off is output to the packet generation means 102 (S11).

When a confirmation is made that the pitch P cannot be detected in the processing of S3 (S3: No), when the detection of the attack has not been confirmed in the processing of S6 (S6: No), or after processing of S7, S9, S10, or S11, the processing of SI and subsequent steps is repeated.

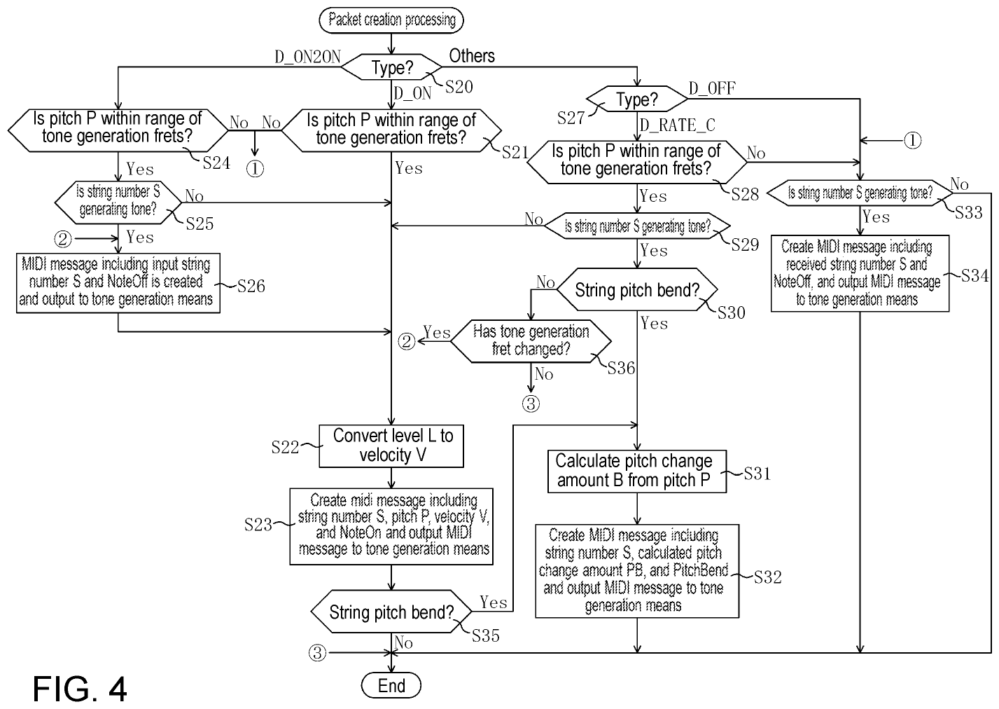

Next, the processing that is executed by the packet generation means 102 will be described with reference to FIG. 4. FIG. 4 is a flowchart of the packet creation processing. The packet creation processing is processing that is executed when the string number S, pitch P, and the like are input through processing of S7, S9, S10, and S11 of the GT analysis processing from any of the GT analysis means 101a to 101f.

In the packet creation processing, first, types input from the GT analysis means 101a to 101f is confirmed (S20). In the processing of S20, when the type is D_ON (S20: D_ON), a confirmation is made as to whether or not the input pitch P is within the range of tone generation frets (S21).

In the present embodiment, the tone generation fret refers to the fret of the guitar G that performs the tone generation, which is set for each string number S by the user H in advance. When the input pitch P is within the range of the tone generation fret, the tone generation by the pitch P is performed, and when the input pitch P is outside the range of the tone generation fret, the tone generation by the pitch P is not performed. Specifically, in the processing of S21, the tone generation fret corresponding to the acquired string number S is acquired, and a confirmation is made as to whether or not the tone generation fret includes a fret corresponding to the acquired pitch P. The fret corresponding to the pitch P is determined on the basis of tuning information according to a setting of the user H.

In the processing of S21, when the input pitch P is within the range of the tone generation frets (S21: Yes), the acquired level L is converted to the velocity V using a known scheme (S22). After the processing of S22, a MIDI message MM including the string number S and the pitch P input from the GT analysis means 101a to 101f, the velocity V converted in the processing of S22, and the note-on is created, and is output to the tone generation means 104 (S23).

When the type is D_ON2ON in the processing of S20 (S20: D_ON2ON), a confirmation is made as to whether or not the input pitch P is within the range of tone generation frets (S24). When the input pitch P is within the range of the tone generation frets in the processing of S24 (S24: Yes), a confirmation is further made as to whether or not the string with the input string number S is generating a tone (S25). When the string with the input string number S is generating a tone in the processing of S25 (S25: Yes), a MIDI message MM including the input string number S and the note-off is created and output to the tone generation means 104 (S26). After the processing of S26, the processing of S22 and subsequent steps is executed.

Accordingly, when the note-on is further performed on the note-on string, a musical tone generated according to previous note-on is muted by a note-off MIDI message MM in the processing of S26, and a musical tone according to subsequent note-on is generated according to the note-on MIDI message MM that is output through the processing of S22 and subsequent steps.

When the string with string number S is not generating the tone in the processing of S25 (S25: No), the processing of S22 and subsequent steps is executed. Accordingly, even when the musical tone according to the previous note-on is muted for some reason, the musical tone according to the subsequent note-on is generated through the processing of S22 and subsequent steps.

When the type is other than D_ON or D_ON2ON in the processing of S20 (S20: the other), another type is further confirmed in the processing of S27. When the type is D_RATE_C (S27: D_RATE_C) in the processing of S27, a confirmation is made as to whether or not the input pitch P is within the range of tone generation frets (S28).

When the input pitch P is within the range of the tone generation frets in the processing of S28 (S28: Yes), a confirmation is made as to whether or not the string with the input string number S is generating a tone (S29). When the string with the input string number S is generating a tone in the processing of S29 (S29: Yes), a confirmation is made as to whether or not the tone generation mode of the synthesizer 1 is the string pitch bend in which the pitch bend is performed on each string (S30). When the tone generation mode is the string pitch bend (S30: Yes) in the processing of S30, the pitch change amount PB that is a difference value between the pitch of the musical tone generated at the string with the input string number S and the input pitch P is calculated (S31).

After the processing of S31, a MIDI message MM including the input string number S, the calculated pitch change amount PB, and pitch bend (PitchBend) is created and output to the tone generation means 104 (S32). Accordingly, a musical tone of which the pitch changes from the pitch of the musical tone generated by the string with the input string number S to the input pitch P is output.

When the string with the input string number S is not generating a tone in the processing of S29 (S29: No), the processing of S22 and subsequent steps is executed. Accordingly, when the pitch P has changed from a state of the outside of the range of the tone generation frets to within the range of the tone generation frets by performing sliding or the like on the string with the input string number S, the corresponding musical tone is generated.

When the type is D_OFF in the processing of S27 (S27: D_OFF), or when the pitch P input in the processing of S21, S24, or S28 is not within the range of tone generation frets (S21, S24, S28: No), a confirmation is made as to whether or not the string with the input string number S is generating a tone (S33). When the string with the input string number S is generating a tone in the processing of S33 (S33: Yes), a MIDI message MM including the input string number S and the note-off is created, and output to the tone generation means 104 (S34).

After the processing of S23, a confirmation is made as to whether or not the tone generation mode is the string pitch bend (S35). When the tone generation mode is the string pitch bend in the processing of S35 (S35: Yes), the processing of S31 and subsequent steps described above is executed.

When the tone generation mode is not the string pitch bend in the processing of S30 (S30: No), a confirmation is made as to whether or not the tone generation fret has changed (S36). In the processing of S36, when the tone generation fret changes (S36: Yes), the processing of S26 and subsequent steps described above is executed.

When the string with the input string number S is not generating the tone in the processing of S33 after the processing of S32 and S34 (S33: No), when the tone generation mode is not the string pitch bend in the processing of S35 (S35: No), or when the tone generation fret has not changed in the processing of S36 (S36: No), the packet creation processing ends.

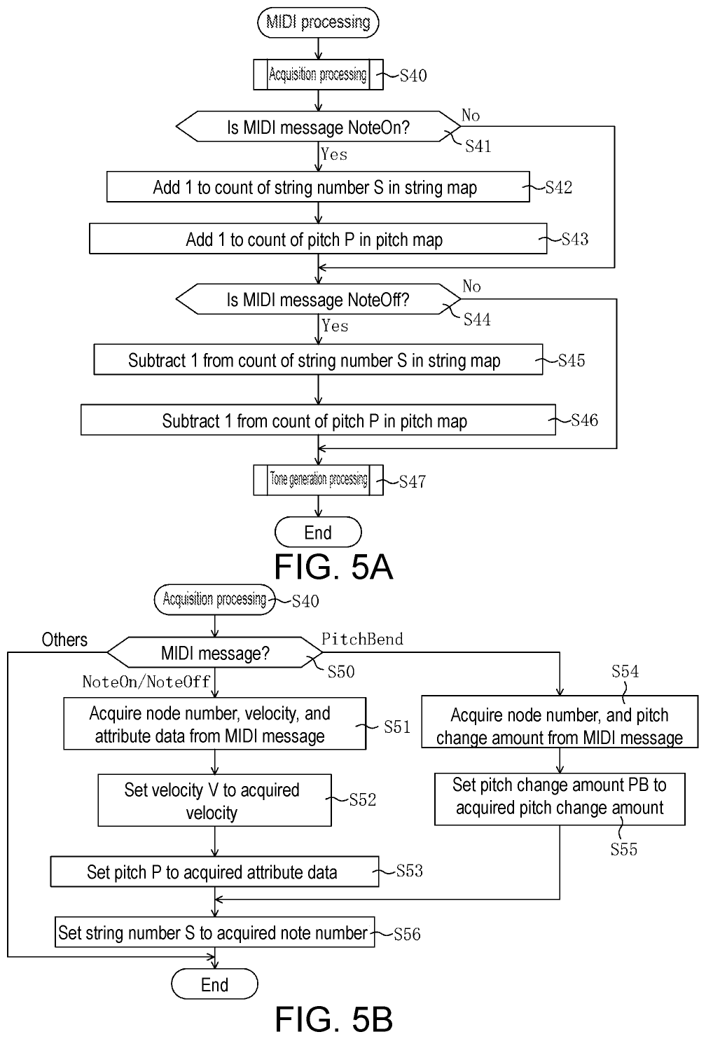

Next, the processing executed by the tone generation means 104 will be described with reference to FIG. 5. FIG. 5A is a flowchart of MIDI processing. The MIDI processing is processing executed in the tone generation means 104 when the MIDI message MM is input from the packet generation means 102 or the PD analysis means 103. In the MIDI processing, first, acquisition processing (S40) is executed. The acquisition processing will now be described with reference to FIG. 5B.

FIG. 5B is a flowchart of the acquisition processing. In the acquisition processing, first, the input MIDI message MM is confirmed (S50). Specifically, in the processing of S50, the value stored in the message type Ma of the input MIDI message MM is confirmed.

When the MIDI message MM is the note-on or the note-off (the value of the message type Ma is “1001” or “1000”) in the processing of S50 (S50: “NoteOn/NoteOff”), the values are acquired from the respective areas of the note number Mn, the velocity Mv, and the attribute data Mad of the input MIDI message MM (see FIG. 2B) (S51). After the processing of S51, the velocity V is set to the value acquired from the velocity Mv (S52). After the processing of S52, a value acquired from the attribute data Mad is set in the pitch P (S53).

When the MIDI message MM is pitch bend (the value of the message type Ma is “0110”) in the processing of S50 (S50: “PitchBend”), the values are acquired from the respective areas of the note number Mn and the pitch change amount Mp of the input MIDI message MM (S54). After the processing of S54, the pitch change amount PB is set to the value acquired from the pitch change amount Mp (S55).

After the processing of S53 and S55, the string number S is set to the value acquired from the note number Mn (S56). In the processing of S50, when the MIDI message MM is neither the note-on, the note-off, nor the pitch bend (S50: “Other”), or after the processing of S56, the acquisition processing ends.

Return to FIG. 5A. After the acquisition processing of S40, a confirmation is made as to whether or not the input MIDI message MM is the note-on (S41). Specifically, a confirmation is made as to whether or not the message type Ma of the input MIDI message is “1001”. When the MIDI message MM is the note-on in the processing of S41 (S41: Yes), “1” is added to the count corresponding to the string number S acquired in the acquisition processing of S40 in the string map 12a (S42), “1” is added to the count corresponding to the pitch P acquired in the acquisition processing of S40 in the pitch map 12b (S43).

When the MIDI message MM is not the note-on in the processing of S41 (S41: No), or after the processing of S43, a confirmation is made as to whether or not the MIDI message MM is the note-off (S44). Specifically, a confirmation is made as to whether or not the message type Ma of the input MIDI message is “1000”.

When the MIDI message MM is the note-off in the processing of S44 (S44: Yes), “1” is subtracted from the count corresponding to the string number S acquired in the acquisition processing of S40 in the string map 12a (S45), “1” is subtracted from the count corresponding to the pitch P acquired in the acquisition processing of S40 in the pitch map 12b (S46).

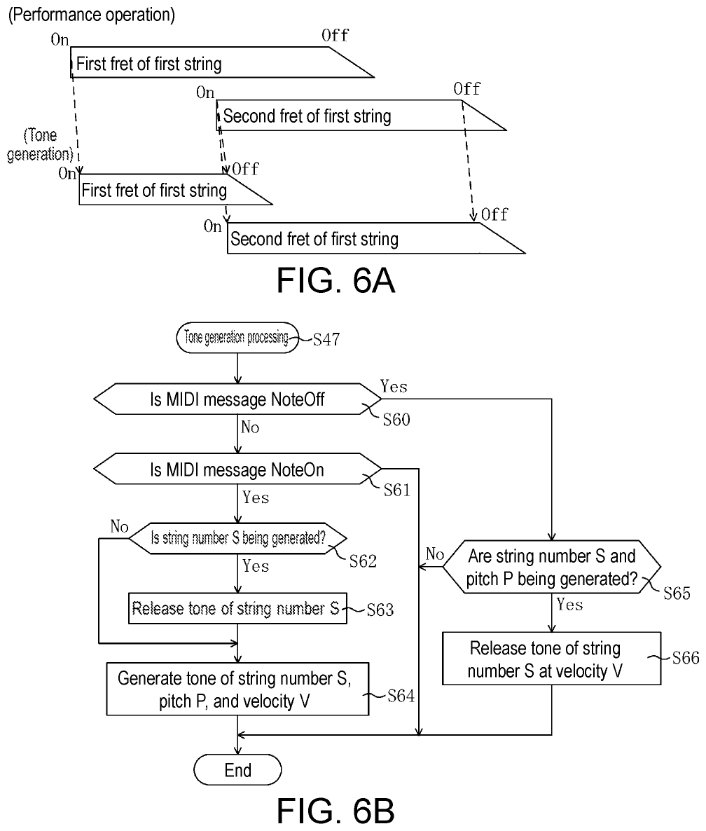

When the MIDI message MM is not the note-off in the processing of S44 (S44: No), or after the processing of S46, the tone generation processing (S47) is executed. In the tone generation processing, processing regarding tone generation according to the tone generation mode of the synthesizer 1 such as “string mono”, which will be described below with reference to FIG. 6, is executed. The tone generation processing in each tone generation mode will be described below with reference to FIG. 6 and subsequent figures. After the tone generation processing of S47, the MIDI processing ends.

Next, the tone generation processing of S47 in each tone generation mode will be described with reference to FIGS. 6 to 10. The synthesizer 1 of the present embodiment outputs musical tones according to the tone generation mode set by the user H. The tone generation modes include “string mono”, “mono”, “mono retrigger”, “string mono retrigger”, “string pitch bend”, “string legato”, and “string mono & hold normal”., “string mono & hold keep,” “string mono & hold string,” and “string mono & sostenuto.” First, the tone generation mode “string mono” will be described with reference to FIG. 6.

FIG. 6A is a diagram illustrating the string mono in the tone generation mode. The string mono is a tone generation mode in which, when note-on of a musical tone of a different fret of a certain string is instructed during note-on of a musical tone of the certain string, a musical tone generated according to previous note-on is muted and a musical tone according to subsequent note-on is generated.

For example, as illustrated in FIG. 6A, when the note-on of the musical tone of the second fret of the first string is instructed during the note-on of the musical tone of the first fret of the first string, the musical tone of the first fret according to previous note-on is muted, and the generation of the musical tone of the second fret according to subsequent note-on is restarted. The tone generation processing of S47 that realizes such string mono will be described with reference to FIG. 6B.

FIG. 6B is a flowchart of the tone generation processing in the string mono. In the string mono tone generation processing, first, a confirmation is made as to whether or not the input MIDI message MM is the note-off (S60). When the input MIDI message MM is not the note-off in the processing of S60 (S60: No), a confirmation is made as to whether or not the input MIDI message MM is the note-on (S61).

When the input MIDI message MM is the note-on in the processing of S61 (S61: Yes), a confirmation is made as to whether or not the string with the string number S acquired in the acquisition processing of S40 is generating a tone (S62). When the string with the string number S is generating the tone in the processing of S62 (S62: Yes), the musical tone of the string number S that is generating the tone is released (muted) (S63).

When the string with the string number S is not generating the tone in the processing of S62 (S62: No), or after the processing of S63, the musical tone with the string number S, pitch P, and velocity V acquired in the acquisition processing of S40 is generated (S64). Accordingly, the musical tone according to previous note-on is muted in the same string number S, and a musical tone according to the subsequent note-on is generated according to the note-on instructed subsequently.

When the input MIDI message MM is the note-off in the processing of S60 (S60: Yes), a confirmation is made as to whether or not the string number S and the pitch P acquired in the acquisition processing of S40 are being generating the tone (S65). When the string number S and the pitch P are being generating the tone in the processing of S65 (S65: Yes), the musical tone of the string number S is released (S66). When the input MIDI message MM is not the note-on in the processing of S61 (S61: No), when the acquired string number S and pitch P are not being generated in the processing of S65 (S65: No), or after the processing of S66, the tone generation processing ends.

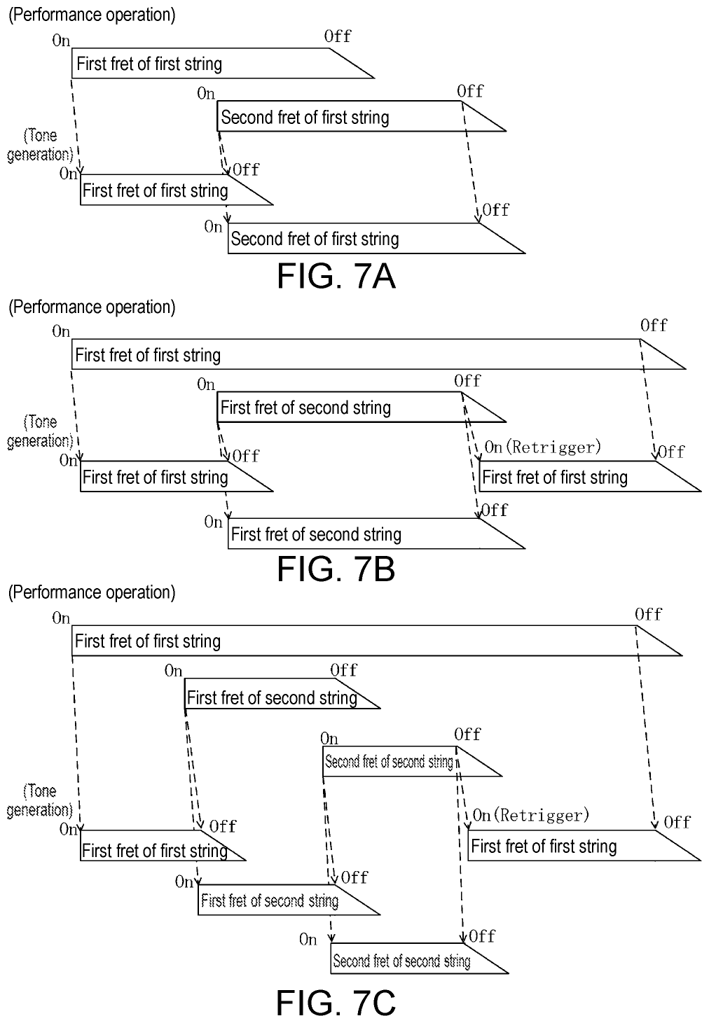

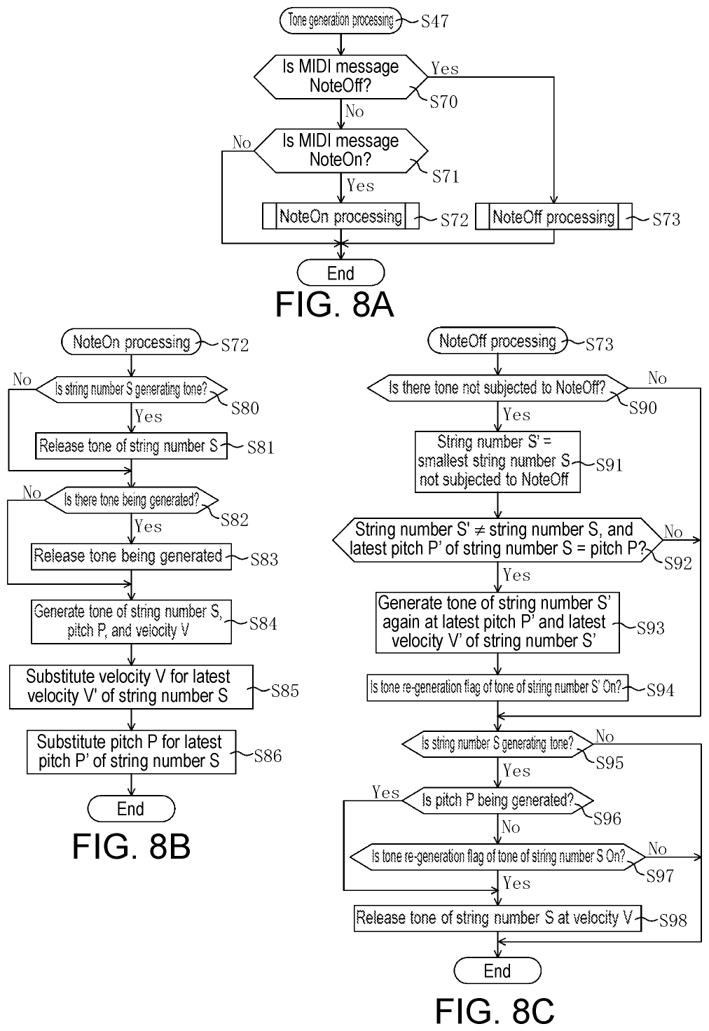

Next, the tone generation modes “mono”, “mono retrigger”, and “string mono retrigger” will be described with reference to FIGS. 7 and 8. First, an overview of the tone generation modes will be described with reference to FIG. 7.

FIG. 7A is a diagram illustrating the mono in the tone generation mode. The mono is a tone generation mode in which, when note-on for a musical tone of another string is instructed during note-on of a musical tone of a certain string, a musical tone generated according to previous note-on is muted and a musical tone according to subsequent note-on is generated.

For example, as illustrated in FIG. 7A, when note-on for the musical tone of the second fret of the second string is instructed during note-on of the musical tone of the first fret of the first string, the musical tone of the first fret of the first string according to previous note-on is muted, and the generation of the musical tone of the second fret of the second string subjected to the note-on later is started.

FIG. 7B is a diagram illustrating mono retrigger in tone generation mode. The mono retrigger is a tone generation mode in which, when note-on of the musical tone of the second string is instructed and then the note-off of the musical tone of the second string is instructed while the musical tone of the first string continues to be note-on, the musical tone generated according to the note-on of the first string is temporarily muted together with the note-on of the musical tone of the second string, and then, the muted musical tone of the first string is generated again together with the note-off of the musical tone of the second string.

For example, as illustrated in FIG. 7B, when the note-on of the musical tone of the first fret of the second string is instructed, and then the note-off of the musical tone of the first fret of the second string is instructed during note-on of the musical tone of the first fret of the first string, the generated musical tone of the first fret of the first string is temporarily muted together with the note-on of the musical tone of the first fret of the second string, and the generation of the muted musical tone of the first fret of the first string is restarted together with the note-on of the musical tone of the first fret of the second string.

FIG. 7C is a diagram illustrating the string mono retrigger in the tone generation mode. The string mono retrigger is a tone generation mode in which the string mono described above in FIG. 6A and the mono retrigger described above in FIG. 7B are combined.

Specifically, this is a tone generation mode in which, when note-on of the musical tone of the first fret of the second string is instructed, and then the note-on of the musical tone of the second fret of the second string is instructed, and then, the note-off is instructed for each of the musical tones of the first fret of the second string and the second fret of the second string while the musical tone of the first string continues to be note-on, the musical tone generated according to the note-on of the first string is temporarily muted together with the note-on of the musical tone of the first fret of the second string, the musical tone generated by the first fret of the second string is muted together with the note-on of the musical tone generated by the second fret of the second string, and the musical tone on the first string temporarily muted is generated again together with the note-off of respective musical tones of the first fret of the second string and the second fret of the second string.

For example, as illustrated in FIG. 7C, when the note-on of the musical tone of the first fret of the second string is instructed, and then the note-off of the musical tone of the first fret of the second string is instructed during note-on of the musical tone of the first fret of the first string, the generated musical tone of the first fret of the first string is temporarily muted together with the note-on of the musical tone of the first fret of the second string, and the generation of muted musical tone of the first fret of the first string is restarted together with the note-on of the musical tone of the first fret of the second string. The tone generation processing of S47 for realizing the mono, mono retrigger, and string mono retrigger will be described with reference to FIG. 8.

FIG. 8A is a flowchart of the tone generation processing in the mono, mono retrigger, and string mono retrigger. In the tone generation processing, first, a confirmation is made as to whether or not the input MIDI message MM is the note-off (S70). When the MIDI message MM is not the note-off in the processing of S70 (S70: No), a confirmation is made as to whether or not the MIDI message MM is the note-on (S71). When the MIDI message MM is the note-on in the processing of S71 (S71: Yes), note-on processing (S72) to be described below is executed in FIG. 8B.

When the input MIDI message MM is the note-off in the processing of S70 (S70: Yes), the note-off processing (S73) to be described below is executed in FIG. 8C. When the input MIDI message MM is not the note-on in the processing of S71 (S71: No), or after the processing of S72 and S73, the tone generation processing ends.

Next, the note-on processing of S72 and the note-off processing of S73 will be described. FIG. 8B is a flowchart of the note-on processing. In the note-on processing, first, a confirmation is made as to whether or not the string with the string number S acquired in the acquisition processing of S40 is generating the tone (S80). When the string with string number S is generating a tone in the processing of S80 (S80: Yes), the musical tone of the string number S of which the tone is generated is released (muted) (S81).

When the string with string number S is not generating the tone in the processing of S80 (S80: No), or after the processing of S81, a confirmation is made as to whether or not there is a tone that is being generated (S82). When there is a tone that is being generated in the processing of S82 (S82: Yes), the tone that is being generated is released (temporarily muted) (S83).

When there is no tone that is being generated in the processing of S82 (S82: No), or after the processing of S83, a musical tone with the string number S, pitch P, and velocity V acquired in the acquisition processing of S40 is generated (S84).

Accordingly, a musical tone according to previous note-on is muted, and a musical tone according to the subsequent note-on is generated according to the note-on instructed subsequently. When the musical tone according to previous note-on is muted, the musical tone is completely muted (released) in a case in which the musical tone according to previous note-on has the same string number S as the subsequently instructed note-on, and the tone is temporarily muted (released) so that the tone re-generation is possible in a case in which the musical tone does not have the same string number S.

After the processing of S83, the velocity V is substituted for the latest velocity V′ of the string number S (S85), the pitch P is substituted for the latest pitch P′ of the string number S (S86), and the note-on processing ends.

FIG. 8C is a flowchart of the note-off processing. In the note-off processing, first, a confirmation is made as to whether or not there is a tone that has not been subjected to the note-off among the tones that are being generated (S90). When there is a tone that has not been subjected to the note-off in the processing of S90 (S90: Yes), the smallest string number S among the string numbers S of the strings that have not been subjected to the note-off is substituted for the string number S′ (S91).

After the processing of S91, a confirmation is made as to whether the string number S′ is not the same as the string number S acquired in the acquisition processing of S40, and the latest pitch P′ of the string number S is the same as the pitch P acquired in the acquisition processing of S40 (S92).

When the string number S′ is not the same as the string number S and the latest pitch P′ of the string number S is the same as the pitch P in the processing of $92 (S92: Yes), the musical tone of the string number S′ is generated again at the latest pitch P′ and the latest velocity V′ of the string number S′ (S93). Accordingly, the tone temporarily muted in the processing of S73 of the note-on processing in FIG. 8B is re-generated. At the time of such tone re-generation, when there is a plurality of string numbers S that have not been subjected to the note-off, the tone of the lowest string number S among these is re-generated by the processing of S91. After the processing of S93, the tone re-generation flag for the tone of the string number S′ is set to ON (S94).

When there is no tone that has not been subjected to the note-off in the processing of S90 (S90: No), when the string number S′ is the same as the string number S or the latest pitch P′ of the string number S is different from the pitch P in the processing of S92 (S92: No), or after the processing of S94, a confirmation is made as to whether or not the string with string number S is generating a tone (S95).

When the string with string number S is generating a tone in the processing of S95 (S95: Yes), a confirmation is made as to whether or not the tone with the pitch P is being generated (S96). When the tone with the pitch P is not generating a tone in S96 (S96: No), a confirmation is made as to whether or not the tone re-generation flag of the tone of the string number S is ON (S97).

When the tone with the pitch P is being generated in the processing of S96 (S96: Yes), or when the tone re-generation flag for the tone of the string number S is ON in the processing of S97 (S97: Yes), the musical tone of the string number S is released (muted) (S98). When the string with string number S is not generating a tone in the processing of S95 (S95: No), the tone re-generation flag for the tone of the string number S is OFF in the processing of S97 (S97: No), or after the processing of S98, the note-off processing ends.

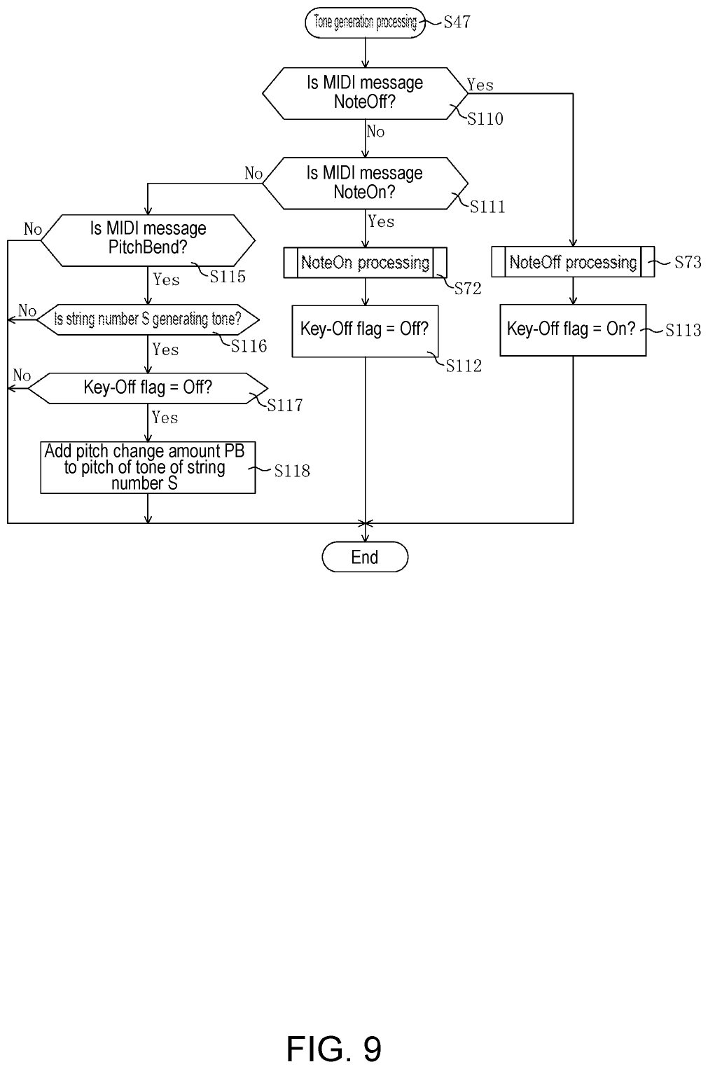

Next, the tone generation mode “string pitch bend” will be described with reference to FIG. 9. The string pitch bend is a tone generation mode in which, when the pitch bend is set in the MIDI message MM with the string number S, the pitch of only the tone generated on the basis of the string with the string number S is changed by the pitch change amount PB set in the MIDI message MM.

FIG. 9 is a flowchart of the tone generation processing in the string pitch bend. In the tone generation processing, first, a confirmation is made as to whether or not the input MIDI message MM is the note-off (S110). When the MIDI message MM is not the note-off in the processing of S110 (S110: No), a confirmation is made as to whether or not the MIDI message MM is the note-on (S111). When the MIDI message MM is the note-on in the processing of S111 (S111: Yes), the note-on processing (S72) of FIG. 8B is executed, and a key-off flag indicating that the tone on which the note-on processing has been performed has been subjected to the note-off is set to OFF (S112).

When the MIDI message MM is note-off in the processing of S110 (S110: Yes), the note-off processing (S73) of FIG. 8C is executed, and the key-off flag is set to ON for the tone on which the note-on processing has been performed (S113). When the MIDI message MM is not the note-on in the processing of S111 (S111: No), a confirmation is made as to whether or not the MIDI message MM is pitch bend (S115).

When the MIDI message MM is pitch bend in the processing of S115 (S115: Yes), a confirmation is made as to whether or not the string with the string number S is generating a tone (S116). When the string with the string number S is generating a tone in the processing of S116

(S116: Yes), a confirmation is made as to whether or not the key-off flag of the tone is OFF (S117). When the key-off flag of the tone is OFF in the processing of S117 (S117: Yes), the pitch change amount PB set in the MIDI message MM is added to the pitch of the tone of the string number S being generated (S118).

As described above, when the tone generation mode of the synthesizer 1 of the present embodiment is “string pitch bend” and pitch bend is set in the acquired MIDI message MM, the pitch of only the tone of the string number S is changed by the pitch change amount PB set in the MIDI message MM.

Incidentally, in the synthesizer 500 of the related art illustrated in FIG. 21, when the pitch bend is designated on the basis of an operation of a certain string, the pitch of not only the tone generated at the string but also all generated tones has been changed by the pitch change amount PB. Accordingly, a pitch of a tone of a string of which no pitch change is intended, other than the string operated by the user H, is also changed, and it is not possible to make fine pitch changes and, for example, it is impossible to generate a musical tone in which there are both of a string of which the pitch is changed through pitch bend and a string of which the pitch is not changed.

On the other hand, in the string pitch bend of the synthesizer 1 of the present embodiment, when a pitch bend instruction is input, the pitch of only the tone of the string number S is changed by the pitch change amount PB set in the MIDI message MM. This makes fine change of the pitch in which both of the pitches are changed on the basis of the pitch change amount PB possible and strings of which pitches are not changed are included.

Further, in the processing of S116, when the tone of the string number S is not generated, the pitch is not changed on the basis of the pitch change amount PB. This makes it possible to perform generation of a tone with the pitch P designated by the user H without an influence of the pitch change based on the pitch change amount PB when the tone of the string number S is generated after the pitch is changed on the basis of the pitch change amount PB.

Further, when the key-off flag is ON in the processing of S117, that is, even when the note-off is performed, the pitch is not changed on the basis of the pitch change amount PB. This is because the synthesizer 1 according to the embodiment outputs an attenuated tone in an aspect that a corresponding musical tone is attenuated after the note-off is designated. When the note-off is instructed, the pitch change based on the pitch change amount PB is not performed, so that change in pitch of the attenuated tone according to the note-off can be curbed, and thus, discomfort of a listener with respect to the attenuated tone can be curbed.

When the MIDI message MM is not pitch bend in the processing of S115 (S115: No), when the string with string number S is not generating a tone in the processing of S116 (S116: No), when the key-off flag of the tone is ON in the processing of S117 (S117: No), or after the processing of S112, S113, and S118, the tone generation processing ends.

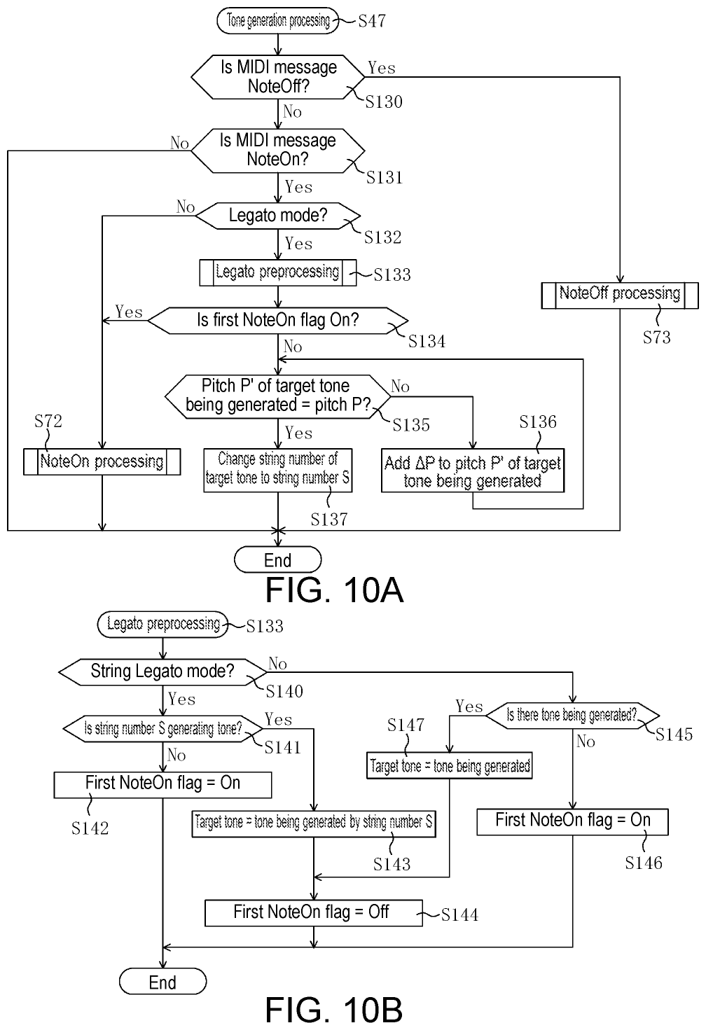

Next, the tone generation mode “string legato” will be described with reference to FIG. 10. The string legato is a tone generation mode in which, when generations of two tones (hereinafter referred to as a “first tone” and a “second tone”) are continuously instructed for the string with the string number S designated by the user H in advance, the pitch of only the string with the string number S is continuously changed (that is, a legato operation) from the instructed first tone to the instructed second tone. Further, in the string legato, when the string numbers S of the first tone and the second tone are different from each other, the legato operation is not performed.

FIG. 10A is a flowchart of the tone generation processing in the string legato. In the tone generation processing, first, a confirmation is made as to whether or not the input MIDI message MM is the note-off (S130). When the MIDI message MM is not the note-off in the processing of S130 (S130: No), a confirmation is made as to whether or not the MIDI message MM is the note-on (S131). When the MIDI message MM is the note-on in the processing of S131 (S131: Yes), a confirmation is made as to whether or not legato is valid (S132). The synthesizer 1 of the present embodiment is configured so that the user H can set whether the legato is valid or invalid.

When the legato is valid in the processing of S132 (S132: Yes), legato preprocessing (S133) is executed. Here, the legato preprocessing will be described with reference to FIG. 10B.

FIG. 10B is a flowchart of the legato preprocessing. In the legato preprocessing, first, a confirmation is made as to whether or not the string legato is valid (S140). The synthesizer 1 of the present embodiment is configured so that the user H can also set whether the string legato is valid or invalid. In the processing of S140, when string legato is valid (S140: Yes), a confirmation is made as to whether or not the string with string number S is generating a tone (S141). When the string with string number S is not generating a tone in the processing of S141 (S141: No), this is a case in which the generation of the first tone has been instructed, and thus, a first note-on flag indicating the generation of the first tone has been instructed is set to ON (S142).

On the other hand, when the string with string number S is generating the tone in the processing of S141 (S141: Yes), the tone generated by the string with string number S is set as the “target tone” to be subjected to legato (S143). After the processing of S143, the first note-on flag is set to OFF (S144).

When the string legato is invalid in the processing of S140 (S140: No) and the generation of two tones are continuously instructed for not only a string that is a target of the string legato but also any string, the pitch is continuously changed regardless of whether or not the strings are straddled from the instructed first tone to the instructed second tone. Therefore, a confirmation is made as to whether or not the tone is being generated from any of the strings, that is, whether there is the tone that is being generated (S145).

When there is no tone that is being generated in the processing of S145 (S145: No), the first note-on flag is set to ON (S146). On the other hand, when there is a tone that is being generated in the processing of S145 (S145: Yes), the “target tone” is set to the tone that is being generated (S147), and the processing of S144 is executed. After the processing of S142, S144, and S146, the legato preprocessing ends.

Return to FIG. 10A. After the legato preprocessing in S133, a confirmation is made as to whether or not the first note-on flag is ON (S134). Since a case in which the first note-on flag is ON in the processing of S134 (S134: Yes) or a case in which the legato is invalid in the processing of S132 (S132: No) is a case in which the first tone in the legato is generated or a case in which the legato is not performed, the note-on processing (S72) in FIG. 8B is executed.

When the first note-on flag is OFF in the processing of S134 (S134: No), the pitch of the “target tone” being generated is changed by legato, and thus, a confirmation is made as to whether or not the pitch P′ of the “target tone” being generated is the same as the pitch P acquired in the processing of S40, that is, the pitch P of the second tone (S135).

When the pitch P′ of the “target tone” being generated is different from the pitch P in the processing of S135 (S135: No), a predetermined pitch value AP is added (S136) so that the pitch P′ of the “target tone” being generated approaches the pitch P, and the processing of S135 is executed again. Accordingly, when the generations of two tones are continuously instructed, the pitch is continuously changed from the instructed first tone to the instructed second tone.

In this case, when the string legato is valid, the pitch is continuously changed only when the string numbers S of the first and second tones are the same, and when the string legato is invalid, the pitch is changed continuously regardless of whether or not the strings are straddled from the instructed first tone to the instructed second tone.

On the other hand, when the pitch P′ of the “target tone” being generated is equal to or higher than the pitch P in the processing of S135 (S135: Yes), the string number of the “target tone” is set to the string number S acquired in the acquisition processing of S40 (S137). When the input MIDI message MM is the note-off in the processing of S130 (S130: Yes), the note-off processing (S73) of FIG. 8C is executed. When the MIDI message MM is not the note-on in the processing of S131 (S131: No), or after the processing of S72, S73, and S145, the tone generation processing ends.

In the processing of S135 and S136, the pitch value AP is added to the pitch of the first tone in order to change the pitch of the instructed first tone to the pitch of the second tone, but the disclosure is not limited thereto. For example, when the pitch of the first tone is higher than the pitch of the second tone, the pitch of the first tone may be changed to the pitch of the second tone by subtracting the pitch value AP from the pitch of the first tone.

Further, the pitch value AP is not limited to a constant value, but may be a variable value. For example, the pitch value AP may be a value corresponding to the difference in pitch between the first tone and the second tone. In this case, when the difference in pitch between the first tone and the second tone is large, a large pitch value AP may be set, and when the difference in pitch between the first tone and the second tone is small, a small pitch value AP may be set so that a time required for the pitch of the first tone to change to the pitch of the second tone may be set constant (for example, two seconds).

Although the legato operation has been described above in FIG. 10, it is also possible to similarly process a portamento operation, which is a playing method that continuously changes from one pitch to another pitch, as in the legato.

Next, the tone generation mode “string mono & hold normal” will be described with reference to FIG. 11. The string mono & hold normal is a tone generation mode in which both a tone generated before the hold pedal is depressed and a tone generated after the hold pedal is depressed continue to be generated when the user H depresses (ON) the hold pedal of the pedal 40 while the same operation as in the tone generation mode “string mono” described above in FIG. 6 is being performed.

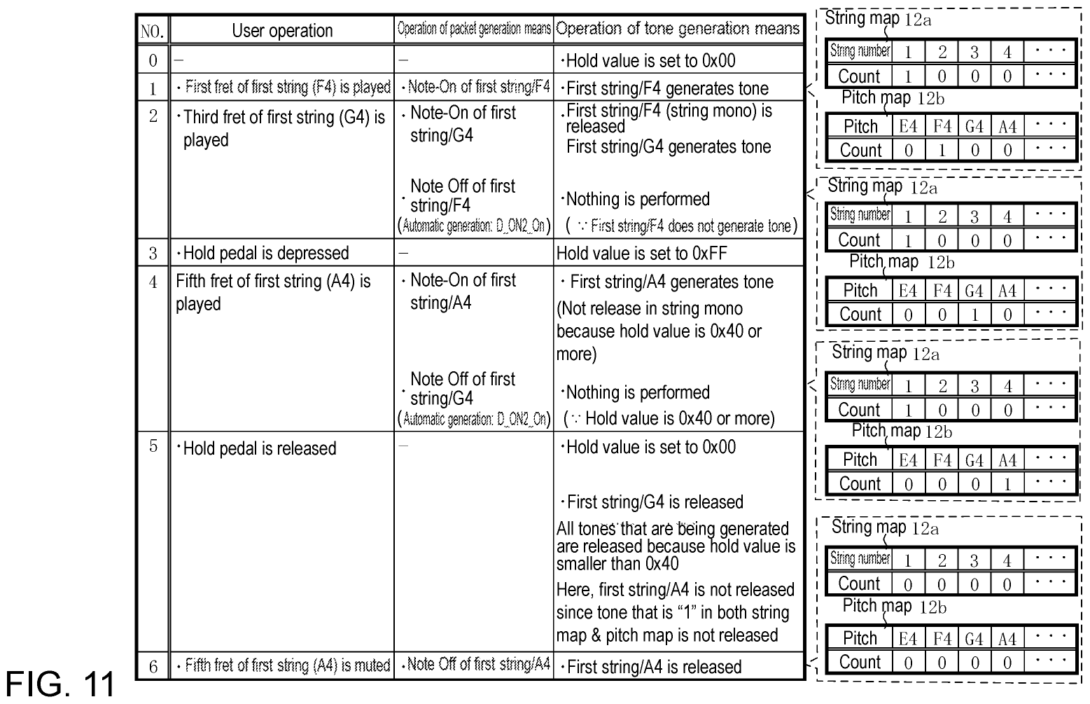

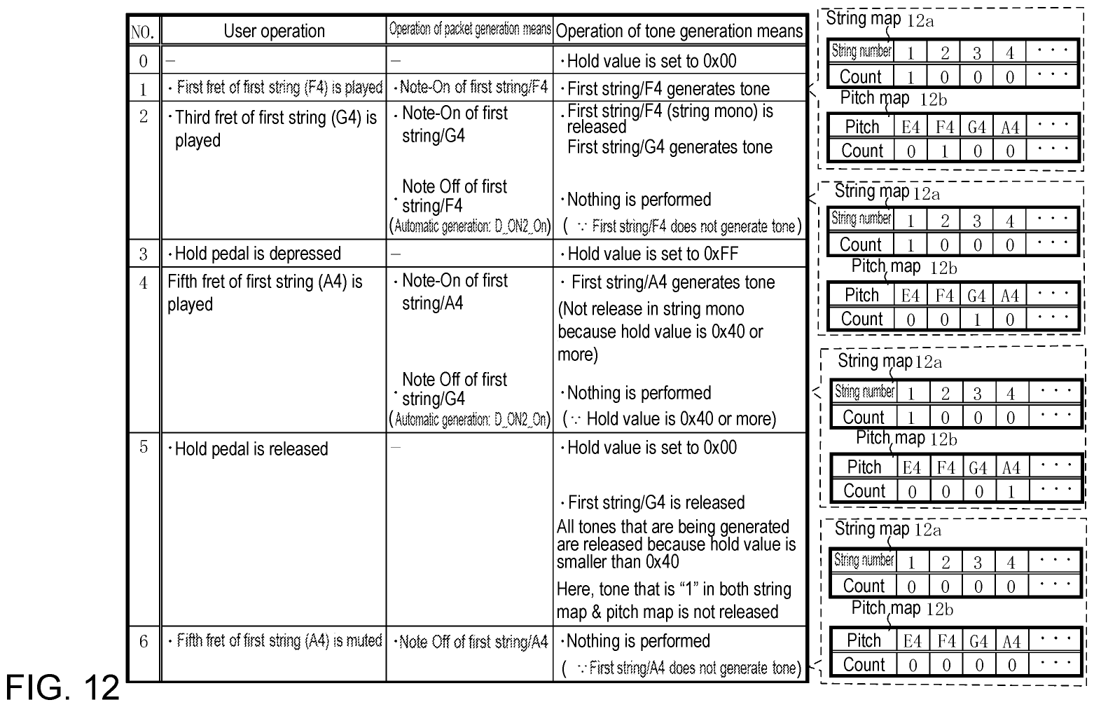

FIG. 11 is a diagram illustrating the string mono & hold normal. In FIG. 11, an operation of the user Hs related to the guitar G or the pedal 40, and an operation of the string mono & hold normal in the packet generation means 102 and the tone generation means 104 are shown. An operation of the user Hs related to the guitar G or the pedal 40, and an operation of each tone generation mode in the packet generation means 102 and the tone generation means 104 are shown, as in FIGS. 12 to 14, which will be described below.

In the string mono & hold normal, first, in the tone generation means 104, a hold value indicating whether the hold pedal is depressed is set to 0×00. The hold value is set to 0×FF when the hold pedal is depressed, and 0×00 when the hold pedal is not depressed.

Thereafter, the user H plays the first fret (F4) of the first string of the guitar G. Then, the packet generation means 102 creates the MIDI message MM for note-on of the tone of the played first fret of the first string (“first string/F4” in the figure), and the tone generation means 104 to which the MIDI message MM is input generates the tone of the first fret of the first string.

Further, the tone generation means 104 adds “1” to the count of string number 1 in the string map 12a and “1” to the count of pitch F4 in the pitch map 12b, on the basis of the input of the note-on of the tone of the first fret of the first string.

Thereafter, the user H plays the third fret of the first string on the guitar G (G4). The packet generation means 102 creates the MIDI message MM for note-on of the tone of the played third fret of the first string (“first string/G4” in the figure). The tone generation means 104 to which the MIDI message MM has been input releases the tone of the first fret of the first string that is generating the tone according to the operation of the string mono, and then generates the tone of the third fret of the first string.

In this case, when the third fret of the first string is played in addition to the first fret of the first string of which the tone has already been generated, the type D_ON2ON is input to the packet generation means 102 through the processing of S9 of the GT analysis processing of FIG. 3, and thus, the MIDI message MM for note-off of the tone of the first fret of the first string is created and input to the tone generation means 104 in the processing of S26 of the packet generation processing in FIG. 4. However, since the tone of the first fret of the first string has already been released according to the operation of the string mono, the tone generation means 104 does nothing.

The tone generation means 104 subtracts “1” from the count of pitch F4 in the pitch map 12b on the basis of the input of the note-on of the tone of the third fret of the first string and the note-off of the tone of the first fret of the first string, and adds “1” to the count of the pitch G4 (the count of string number 1 in the string map 12a remains “1” since “1” is subtracted after “1” is added).

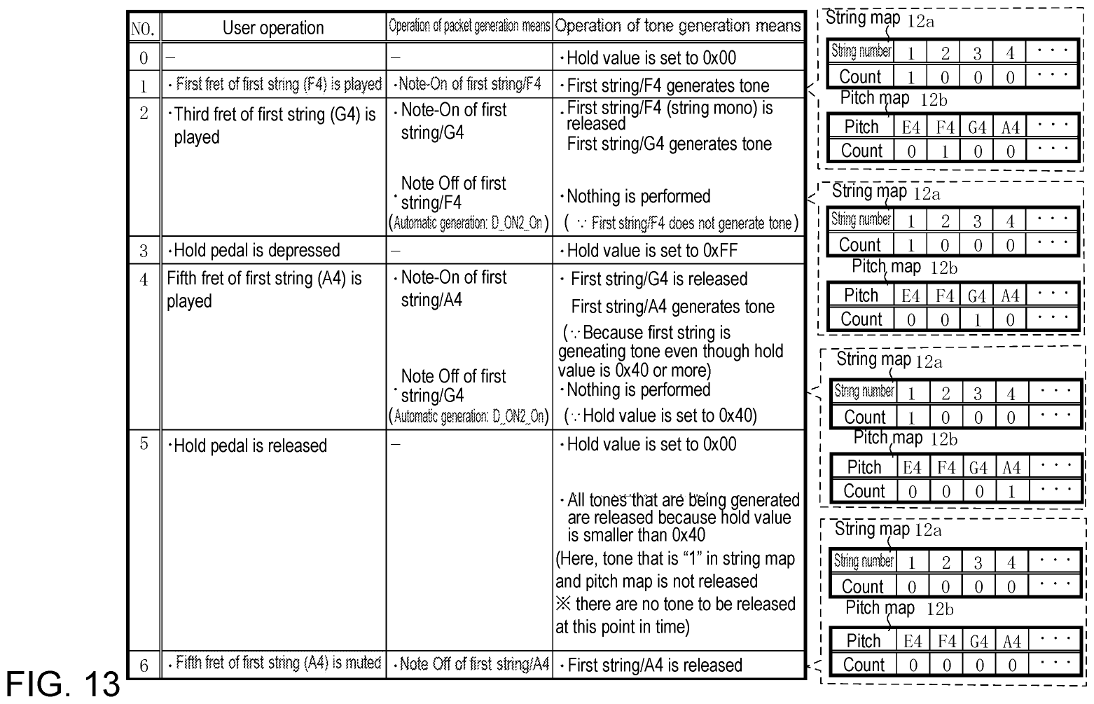

Thereafter, the user H depresses the hold pedal. Accordingly, the tone generation means 104 sets the hold value to 0×FF. It is assumed that the hold pedal is continued to be depressed until a timing to be described below when the user H releases the hold pedal (the same applies to FIGS. 12 and 13, which will be described below).

After the user H depresses the hold pedal, the user H plays a fifth fret (A4) of a first string on the guitar G. The packet generation means 102 generates a MIDI message MM for note-on of the tone of the played fifth fret of the first string (“first string/A4” in the figure). The tone generation means 104 to which the MIDI message MM has been input generates the tone of the fifth fret of first string.

In this case, since the hold value (=0×FF) is equal to or greater than 0×40 that is the threshold value, the release of the tone of the third fret of the first string that is being generated by the string mono is not performed. Further, when the fifth fret of the first string is played in addition to the third fret of the first string of which the tone has already been generated, the packet generation means 102 creates the MIDI message MM for note-off of the tone of the third fret of the first string according to the type D_ON2ON and inputs the MIDI message MM to the tone generation means 104, but does not perform the release using the MIDI message MM since the hold value (=0×FF) is equal to or greater than 0×40 that is the threshold value. In this case, “1” is subtracted from the count of the pitch G4 of the pitch map 12b, on the basis of the input of the MIDI message MM for note-off of the tone of the third fret of the first string.

Through these operations, the tone of the third fret of the first string generated before the user H depresses the hold pedal and the tone of the fifth fret of the first string generated after the user H depresses the hold pedal continue to be generated. The tone generation means 104 subtracts “1” from the count of pitch A4 in the pitch map 12b on the basis of the input of the note-on of the tone of the fifth fret of the first string and the note-off of the tone of the third fret of the first string, and adds “1” to the count of the pitch G4 (the count of string number 1 in the string map 12a remains “1” since “1” is subtracted after “1” is added).

Thereafter, when the user H releases the hold pedal that the user His depressing, the tone generation means 104 sets the hold value to 0×00. Accordingly, since the hold value (=0×00) becomes smaller than 0×40 that is the threshold value, a tone for which “0” is set in the count of each of the string map 12a and the pitch map 12b among all the tones being generated is released. In the case of FIG. 11, the tone of the third fret of the first string is released. On the other hand, the fifth fret of the first string for which “1” or more is set in the count of each of the string map 12a and the pitch map 12b is not released, and the tone generation is continued.

Further, thereafter, when the user H mutes the fifth fret of the first string, the packet generation means 102 creates a MIDI message MM for note-off of the tone of the played fifth fret of the first string, and the tone generation means 104 to which the MIDI message MM has been input releases the tone of the fifth fret of the first string. The tone generation means 104 subtracts “1” from the count of string number 1 in the string map 12a and “1” from the count of pitch A4 in the pitch map 12b, on the basis of an input of the note-off of the tone of the fifth fret of the first string.

Next, the tone generation mode “string mono & hold keep” will be described with reference to FIG. 12. The string mono & hold keep is a tone generation mode in which, when the user H depresses the hold pedal while the same operation as in the “string mono” is being performed, the generation of the tone generated before the hold pedal is depressed is continued, and the generation of a tone instructed after the hold pedal is depressed is not performed.

FIG. 12 is a diagram illustrating string mono & hold keep. In the string mono & hold keep, first, the tone generation means 104 sets the hold value to 0×00. Thereafter, the user H plays the first fret (F4) of the first string of the guitar G. Then, the packet generation means 102 generates a MIDI message MM for note-on of the tone of the played first fret of the first string, and the tone generation means 104 to which the MIDI message MM has been input generates the tone of the first fret of the first string.

Further, the tone generation means 104 adds “1” to the count of string number 1 in the string map 12a and “1” to the count of pitch F4 in the pitch map 12b, on the basis of the input of the note-on of the tone of the first fret of the first string.

Thereafter, the user H plays the third fret of the first string on the guitar G (G4). The packet generation means 102 creates the MIDI message MM for note-on of the tone of the played third fret of the first string. The tone generation means 104 to which the MIDI message MM has been input releases the tone of the first fret of the first string that is generating the tone according to the operation of the string mono, and then generates the tone of the third fret of the first string.

In this case, when the third fret of the first string is played in addition to the first fret of the first string of which the tone has already been generated, the type D_ON2ON is input to the packet generation means 102, and thus, the MIDI message MM for note-off of the tone of the first fret of the first string is created and input to the tone generation means 104. However, since the tone of the first fret of the first string has already been released according to the operation of the string mono, the tone generation means 104 does nothing.

The tone generation means 104 subtracts “1” from the count of pitch F4 in the pitch map 12b on the basis of the input of the note-on of the tone of the third fret of the first string and the note-off of the tone of the first fret of the first string, and adds “1” to the count of the pitch G4 (the count of string number 1 in the string map 12a remains “1” since “1” is subtracted after “1” is added).

Thereafter, the user H depresses the hold pedal. Accordingly, the tone generation means 104 sets the hold value to 0×FF.

After the user H depresses the hold pedal, the user H plays the fifth fret (A4) of the first string on the guitar G. The packet generation means 102 creates the MIDI message MM for note-on of the tone of the played fifth fret of the first string. In the tone generation means 104 to which the MIDI message MM has been input, since the hold value is set to 0×FF, which is greater than 0×40 that is the threshold value, the generation of the tone of the fifth fret of the first string based on the input MIDI message MM is not performed, and the release of the tone of the third fret of the first string according to an operation of the string mono is not performed.

Further, when the fifth fret of the first string is played in addition to the third fret of the first string of which the tone has already been generated, the packet generation means 102 creates the MIDI message MM for note-off of the tone of the third fret of the first string according to the type D_ON2ON and inputs the MIDI message MM to the tone generation means 104, but does not perform the release using the MIDI message MM since the hold value (=0×FF) is equal to or greater than 0×40 that is the threshold value.

Through these operations, the generation of the tone of the third fret of the first string generated before the user H depresses the hold pedal is generated, while the generation of the tone of the fifth fret of the first string instructed after the user H has depressed the hold pedal is not performed by the synthesizer 1. However, since the vibration of the first string based on the user

H playing the fifth fret of the first string is performed, a (live) tone based on the vibration is continued. Accordingly, a richly expressive musical tone in which the tone of the third fret of the first string generated by the synthesizer 1 is combined with a raw tone based on the user H playing the fifth fret of the first string can be generated.

The tone generation means 104 subtracts “1” from the count of pitch G4 in the pitch map 12b on the basis of the input of the note-on of the tone of the fifth fret of the first string and the note-off of the tone of the third fret of the first string, and adds “1” to the count of the pitch F4 (the count of string number 1 in the string map 12a remains “1” since “1” is subtracted after “1” is added).

Thereafter, when the user H releases the hold pedal that the user His depressing, the tone generation means 104 sets the hold value to 0×00. Accordingly, since the hold value (=0×00) becomes smaller than 0×40 that is the threshold value, a tone for which “0” is set in the count of each of the string map 12a and the pitch map 12b among all the tones being generated is released. In the case of FIG. 12, the tone of the third fret of the first string is released. On the other hand, a tone for which respective counts of the string map 12a and the pitch map 12b are set to “1” or more is not released and the tone generation is continued.

Further, thereafter, the user H mutes the fifth fret of the first string, so that the packet generation means 102 creates a MIDI message MM for note-off of the tone of the played fifth fret of the first string, and the MIDI message MM is input to the tone generation means 104, but since the tone of the fifth fret of the first string is not being generated in the first place, no operation is performed. The tone generation means 104 subtracts “1” from the count of string number 1 in the string map 12a and “1” from the count of pitch A4 in the pitch map 12b, on the basis of an input of the note-off of the tone of the fifth fret of the first string.

Next, the tone generation mode “string mono & hold string” will be described with reference to FIG. 13. The string mono & hold string is a tone generation mode in which, when the user H depresses the hold pedal while the same operation as in “string mono” is performed, the tone generated before the hold pedal is depressed is released (temporarily muted), and generation of a tone instructed after the hold pedal is depressed is performed.

FIG. 13 is a diagram illustrating the string mono & hold string. In the string mono & hold string, first, the tone generation means 104 sets the hold value to 0×00. Thereafter, the user H plays the first fret (F4) of the first string of the guitar G. Then, the packet generation means 102 generates a MIDI message MM for note-on of the tone of the played first fret of the first string, and the tone generation means 104 to which the MIDI message MM has been input generates the tone of the first fret of the first string.

Further, the tone generation means 104 adds “1” to the count of string number 1 in the string map 12a and “1” to the count of pitch F4 in the pitch map 12b, on the basis of the input of the note-on of the tone of the first fret of the first string.

Thereafter, the user H plays the third fret of the first string of the guitar G (G4). The packet generation means 102 creates a MIDI message MM for note-on of the tone of the played third fret of the first string. The tone generation means 104 to which the MIDI message MM has been input releases the tone of the first fret of the first string of which the tone has already been generated according to the operation of the string mono, and then generates the tone of the third fret of the first string.

In this case, when the third fret of the first string is played in addition to the first fret of the first string of which the tone has already been generated, the type D_ON2ON is input to the packet generation means 102, and thus, the MIDI message MM for note-off of the tone of the first fret of the first string is created and input to the tone generation means 104. However, since the tone of the first fret of the first string has already been released according to the operation of the string mono, the tone generation means 104 does nothing.

The tone generation means 104 subtracts “1” from the count of pitch F4 in the pitch map 12b on the basis of the input of the note-on of the tone of the third fret of the first string and the note-off of the tone of the first fret of the first string, and adds “1” to the count of the pitch G4 (the count of string number 1 in the string map 12a remains “1” since “1” is subtracted after “1” is added).

Thereafter, the user H depresses the hold pedal. Accordingly, the tone generation means 104 sets the hold value to 0×FF.

After the user H depresses the hold pedal, the user H plays the fifth fret (A4) of the first string on the guitar G. The packet generation means 102 generates a MIDI message MM for note-on of the tone of the played fifth fret of the first string. In the tone generation means 104 to which the MIDI message MM has been input, since the hold value is set to 0×FF and is equal to or greater than 0×40 that is the threshold value and the first string is generating a tone, the tone of the third fret of first string that is generating the tone is released (temporarily muted), and instead, generation of the tone of the fifth fret of first string based on the input MIDI message MM is performed.

Further, when the fifth fret of the first string is played in addition to the third fret of the first string of which the tone has already been generated, the packet generation means 102 creates the MIDI message MM for note-off of the tone of the third fret of the first string according to the type D_ON2ON and inputs the MIDI message MM to the tone generation means 104, but does not perform the release using the MIDI message MM since the hold value (=0×FF) is equal to or greater than 0×40 that is the threshold value. In this case, “1” is subtracted from the count of the pitch G4 of the pitch map 12b, on the basis of the input of the MIDI message MM for note-off of the tone of the third fret of the first string.

With these operations, the tone of the third fret of the first string generated before the user H depresses the hold pedal is released (temporarily muted), and the generation of the tone of the fifth fret of first string instructed after the hold pedal has been depressed is performed.

The tone generation means 104 subtracts “1” from the count of pitch G4 in the pitch map 12b on the basis of the input of the note-on of the tone of the fifth fret of the first string and the note-off of the tone of the third fret of the first string, and adds “1” to the count of the pitch F4 (the count of string number 1 in the string map 12a remains “1” since “1” is subtracted after “1” is added).

Thereafter, when the user H releases the hold pedal that the user His depressing, the tone generation means 104 sets the hold value to 0×00. Accordingly, since the hold value (=0×00) becomes smaller than 0×40 that is the threshold value, a tone for which “0” is set in the count of each of the string map 12a and the pitch map 12b among all the tones being generated is released. In the case of FIG. 13, since there is no tone for which “0” is set in the count of each of the string map 12a and the pitch map 12b among all the tones being generated, the release is not performed. On the other hand, the fifth fret of the first string for which “1” or more is set in the count of each of the string map 12a and the pitch map 12b is not released, and the tone generation is continued.

Further, thereafter, when the user H mutes the fifth fret of the first string, the packet generation means 102 creates a MIDI message MM for note-off of the tone of the played fifth fret of the first string, and the tone generation means 104 to which the MIDI message MM has been input releases the tone of the fifth fret of the first string. The tone generation means 104 subtracts “1” from the count of string number 1 in the string map 12a and “1” from the count of pitch A4 in the pitch map 12b, on the basis of an input of the note-off of the tone of the fifth fret of the first string.

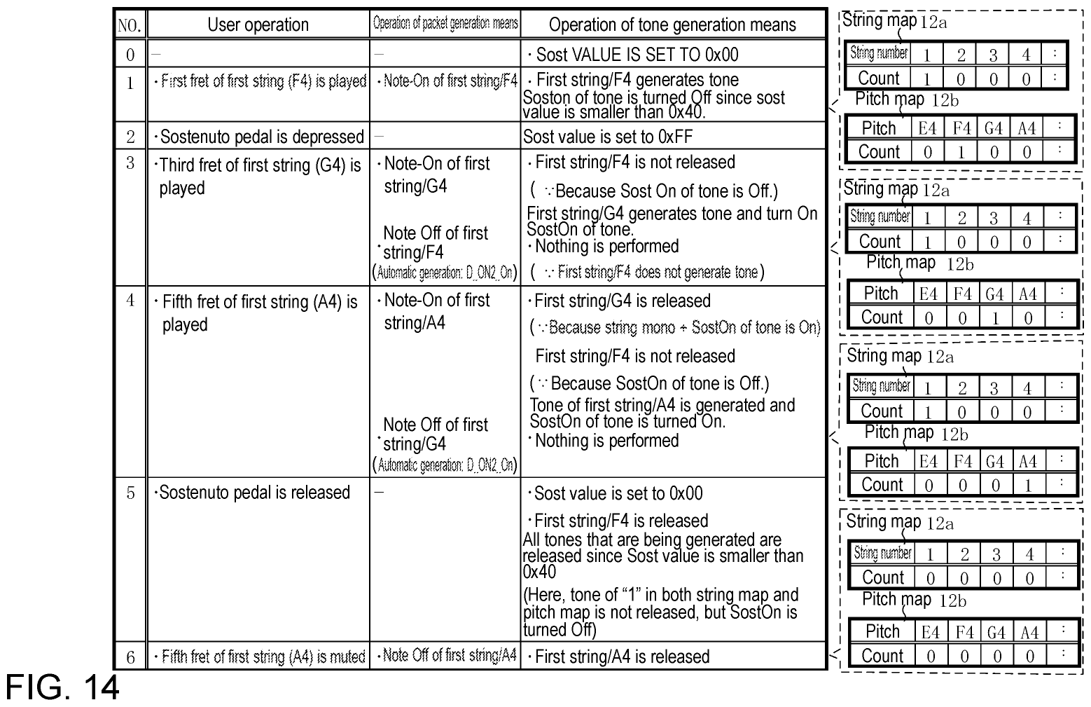

Next, the tone generation mode “string mono & sostenuto” will be described with reference to FIG. 14. The string mono & sostenuto is a tone generation mode in which, when the user H depresses the sostenuto pedal of the pedal 40 while the same operation as in “string mono” is being performed, the tone generation of the tone started before the sostenuto pedal is depressed is continued, and only the most recently instructed tone on the string among the tones instructed after the sostenuto pedal is depressed is generated.

FIG. 14 is a diagram illustrating the string mono & sostenuto. In the string mono & sostenuto, first, in the tone generation means 104, a Sost value indicating whether the sostenuto pedal is depressed is set to 0×00. the Sost value is set to 0×FF when the sostenuto pedal is depressed and is set to 0×00 when the sostenuto pedal is not depressed, similarly to the hold value.

Thereafter, the user H plays the first fret (F4) of the first string of the guitar G. Then, the packet generation means 102 generates a MIDI message MM for note-on of the tone of the played first fret of the first string, and the tone generation means 104 to which the MIDI message MM has been input generates the tone of the first fret of the first string.

Further, the tone generation means 104 adds “1” to the count of string number 1 in the string map 12a and “1” to the count of pitch F4 in the pitch map 12b, on the basis of the input of the note-on of the tone of the first fret of the first string.

In this case, the tone generation means 104 sets a SostOn flag of the first fret of the first string to OFF. The SostOn flag is a flag that is set for each tone (that is, string and pitch), and the SostOn flag for the tone generated before the sostenuto pedal is depressed is set to OFF, while the SostOn flag for the tone generated after the sostenuto pedal is depressed is set to ON. Although details will be described below, the tone generation of the tone for which the SostOn flag is OFF continues even after the sostenuto pedal is depressed.

Thereafter, the user H depresses the sostenuto pedal. Accordingly, the tone generation means 104 sets the Sost value to 0×FF. It is assumed that the sostenuto pedal can also be continued to be depressed until a timing to be described below when the user H releases the sostenuto pedal.

After the user H depresses the sostenuto pedal, the user H plays the third fret (G4) of the first string on the guitar G. The packet generation means 102 generates a MIDI message MM for note-on of the tone of the played third fret of the first string. In the tone generation means 104 to which the MIDI message MM has been input, first, since the SostOn flag of the first fret of the first string which is generating a tone is OFF, the release of the first fret of the first string is not performed. Accordingly, the tone generation of the tone started before the sostenuto pedal is depressed continues.

On the basis of the input MIDI message MM for note-on of the tone of the third fret of the first string, the tone generation means 104 generates the tone of the third fret of the first string, and sets the SostOn flag for the third fret of the first string to ON.

In this case, when the third fret of the first string is played in addition to the first fret of the first string of which the tone has already been generated, the type D_ON2ON is input to the packet generation means 102, and thus, the MIDI message MM for note-off of the tone of the first fret of the first string is created and input to the tone generation means 104. However, since the tone of the first fret of the first string is not released due to the SostOn flag being OFF, the tone generation means 104 does nothing.

The tone generation means 104 subtracts “1” from the count of pitch F4 in the pitch map 12b on the basis of the input of the note-on of the tone of the third fret of the first string and the note-off of the tone of the first fret of the first string, and adds “1” to the count of the pitch G4 (the count of string number 1 in the string map 12a remains “1” since “1” is subtracted after “1” is added).

Thereafter, the user H plays the fifth fret (A4) of the first string on the guitar G. The packet generation means 102 generates a MIDI message MM for note-on of the tone of the played fifth fret of the first string. The tone generation means 104 to which the MIDI message MM has been input releases the tone of the third fret of the first string that is generating the tone. This release is performed because the SostOn flag of the third fret of the first string is ON, in addition to the string mono.

On the other hand, the tone of the first fret of the first string that is generating the tone is not released because the corresponding SostOn flag is OFF. On the basis of the MIDI message MM for note-on of the tone of the fifth fret of the first string, the tone of the fifth fret of the first string is generated, and the SostOn flag for the fifth fret of the first string is set to ON. Accordingly, the generation of the tone started before the sostenuto pedal is depressed (that is, the tone of the first fret of the first string) continues, and for the tone instructed to be generated after the sostenuto pedal is depressed, only the most recently instructed tone (that is, the tone of the fifth fret of the first string) in the string is generated.

The tone generation means 104 subtracts “1” from the count of pitch G4 in the pitch map 12b on the basis of the input of the note-on of the tone of the fifth fret of the first string and the note-off of the tone of the third fret of the first string, and adds “1” to the pitch A4 (the count of string number 1 in the string map 12a remains “1” since “1” is subtracted after “1” is added).

Thereafter, when the user H releases the depressed sostenuto pedal, the tone generation means 104 sets the Sost value to 0×00. Accordingly, since the Sost value (=0×00) becomes smaller than 0×40 that is the threshold value, the tone that is being generated is released. In this case, the tone for which the counts of the string map 12a and the pitch map 12b are set to “1” is not released. Therefore, in the case of FIG. 14, the tone of the first fret (F4) of the first string for which the count of the pitch map 12b is set to 0 is released, and the tone of the fifth fret (A4) of the first string for which the count of each of the string map 12a and the pitch map 12b is set to “1” is not released. Further, in this case, the SostOn flags of the tones not released are all set to OFF.

Further, thereafter, when the user H mutes the fifth fret of the first string, the packet generation means 102 creates a MIDI message MM for note-off of the tone of the played fifth fret of the first string, and the tone generation means 104 to which the MIDI message MM has been input releases the tone of the fifth fret of the first string. The tone generation means 104 subtracts “1” from the count of string number 1 in the string map 12a and “1” from the count of pitch A4 in the pitch map 12b, on the basis of an input of the note-off of the tone of the fifth fret of the first string.

The “string mono & hold normal” in FIG. 11 and the “string mono & sostenuto” in FIG. 14 are not limited to operating separately, and may be used in combination.

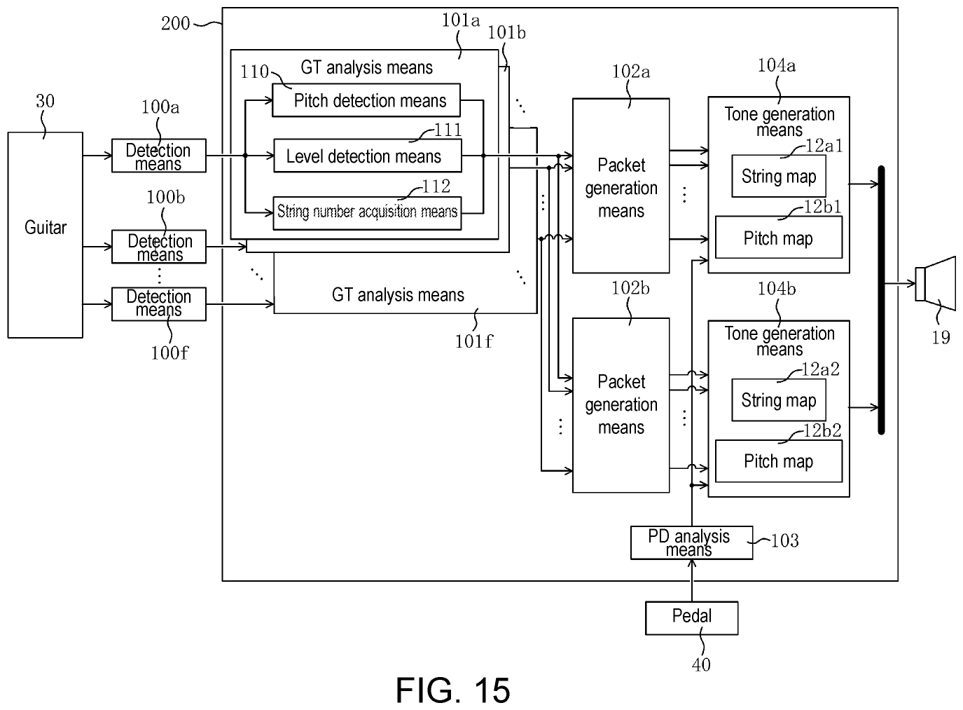

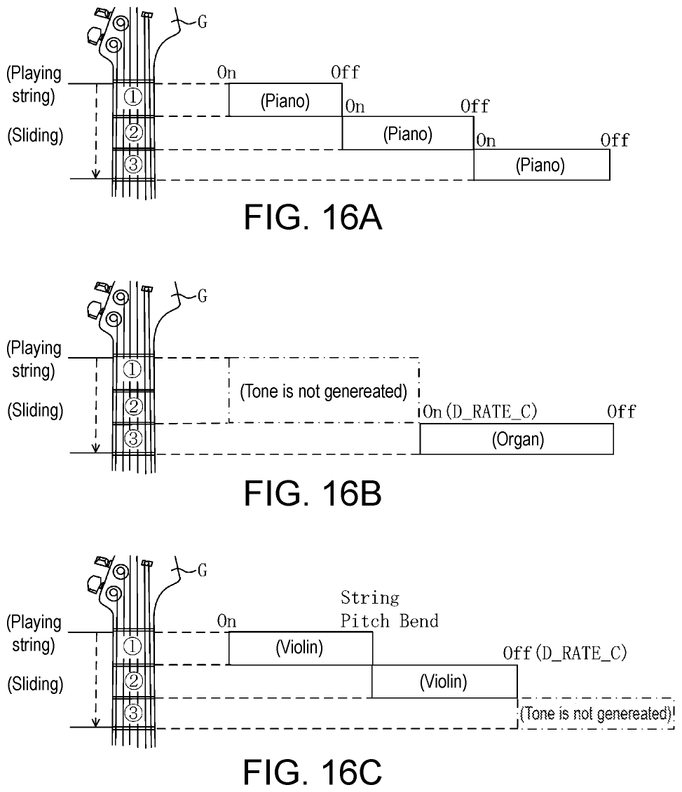

Next, the synthesizer 200 of the second embodiment will be described with reference to FIGS. 15 and 16. In the synthesizer 1 of the first embodiment described above, a configuration in which only one tone generation means 104 is provided has been adopted. On the other hand, in the synthesizer 200 of the second embodiment, a configuration in which the two tone generation means 104a and 104b are provided, and aspects of the musical tone such as tone color can be independently set in the tone generation means 104a and 104b has been adopted. The same configurations as those of the first embodiment described above are denoted by the same reference numerals, and detailed description thereof will be omitted.

FIG. 15 is a functional block diagram of the synthesizer 200 of the second embodiment. In the synthesizer 200 of the second embodiment, the two tone generation means 104a and 104b are provided. Packet generation means 102a and 102b are provided in the respective tone generation means 104a and 104b. Specifically, the packet generation means 102a is provided in the tone generation means 104a, and the packet generation means 102b is provided in the tone generation means 104b.

Further, each of the packet generation means 102a and 102b is configured so that the tone generation fret for each string number S described above can be independently set, and further, the tone generation means 104a and 104b are configured so that tone color of the musical tone generated at each of the tone generation frets can be independently set. Accordingly, the synthesizer 200 of the second embodiment can output a richly expressive musical tone in which the fret generating a tone or a tone color of the generated tone is combined, unlike the synthesizer of the first embodiment in which only one tone generation means 104 is provided.

Next, an operation of the tone generation mode “string pitch bend” using the synthesizer 200 of the second embodiment will be described with reference to FIG. 16. FIG. 16A to FIG. 16C are diagrams each illustrating the string pitch bending in the tone generation mode using the synthesizer 200 of the second embodiment.

In FIG. 16A, the tone color of the tone generation means 104a is set to a piano, the tone generation frets of the packet generation means 102a are set the first to third frets, and a setting not using the string pitch bend is made. In this case, when the user H depresses the first fret of the third string, plays the third string, and then performs, sliding or the like from the first fret of the third string to the third fret of the third string as they are, the first fret of the third string is first played so that a piano tone with the pitch P corresponding to the fret is generated. When the second fret is reached, the piano tone with the pitch P corresponding to the first fret is stopped, and instead, the piano tone with the pitch P corresponding to the second fret is generated. Similarly, when the third fret is reached, the piano tone with the pitch P corresponding to the second fret is stopped, and instead, the piano tone with the pitch P corresponding to the third fret is generated.

In FIG. 16B, the tone color of the tone generation means 104a is set to organ, only the fourth fret is set as the tone generation fret of the packet generation means 102a, and a setting not using the string pitch bend is made. In this case, when the user H depresses the first fret of the fourth string, plays the fourth string, and then performs sliding or the like from the first fret of the fourth string to the third fret of the fourth string as they are, the tone is not generated even when the first fret of the fourth string is first played, and an organ tone with the pitch P corresponding to the third fret of the fourth string is generated when the third fret is reached by performing the sliding or the like as it is.

The start of generation of the organ tone in a case in which the sliding or the like is performed up to such a third fret is realized by note-on processing when the type is D_RATE_C, the pitch P is within the tone generation fret, and the string number S (=fourth string) is not generating the tone according to S27 to S29, S22, and S23 in the packet creation processing of FIG. 4.

Further, in FIG. 16C, the tone color of the tone generation means 104a is set to violin, only the first and second frets are set as the tone generation frets of the packet generation means 102a, and a setting using the string pitch bend is made. In this case, when the user H depresses the first fret of the fifth string, plays the fifth string, and then performs sliding or the like from the first fret of the fifth string to the third fret of the fifth string as they are, the first fret of the fifth string is played so that a violin tone with the pitch P corresponding to the fret is generated, and the sliding or the like to the second fret is performed as it is and the tone is generated so that continue change occurs from the violin tone with the pitch P corresponding to the first fret to the violin tone with the pitch P corresponding to the second fret. Thereafter, when the sliding or the like is performed on the third fret, this is outside the range of the tone generation fret, and thus, the tone generation of the violin tone is stopped.

The stopping of the tone generation due to such sliding or the like to the third fret is realized by the note-off processing when the type is D_RATE_C, the pitch P is outside the tone generation fret, and the string number S (=fifth string) is generating a tone according to S27, S28, S33, and S34 in the packet creation processing of FIG. 4.

Thus, it is possible to output a richly expressive musical tone in which tone generation/non-generation using the fret or a type of tone color to be generated is combined, by setting various frets or tone color to be generated.

Further, for example, the setting of FIG. 16A is performed by the packet generation means 102a and the tone generation means 104a, and the settings of FIG. 16C is performed by the packet generation means 102b and the tone generation means 104b so that the first frets of the third string and fifth string can be simultaneously curbed and played, and the sliding or the like is performed on only the third string to the third fret, making it possible to change only the pitch P of the third string without changing the pitch P of the musical tone generated by the fifth string. Accordingly, since musical tones obtained by changing the respective pitches P of musical tones of the piano tone and the violin tone can be simultaneously generated, it is possible to output a richly expressive musical tone.

In FIGS. 15 and 16, tone color has been set for each of the tone generation means 104a and 104b, but the disclosure is not limited thereto. Further, a configuration may be such that the tone color can be set for each of ranges of the tone generation frets. For example, the first to third frets may be set to generate piano tones, and the fourth to sixth frets may be set to generate organ tones. With this setting, when the string pitch bend is performed, the pitch P can be changed continuously, and the tone color can also be changed continuously.

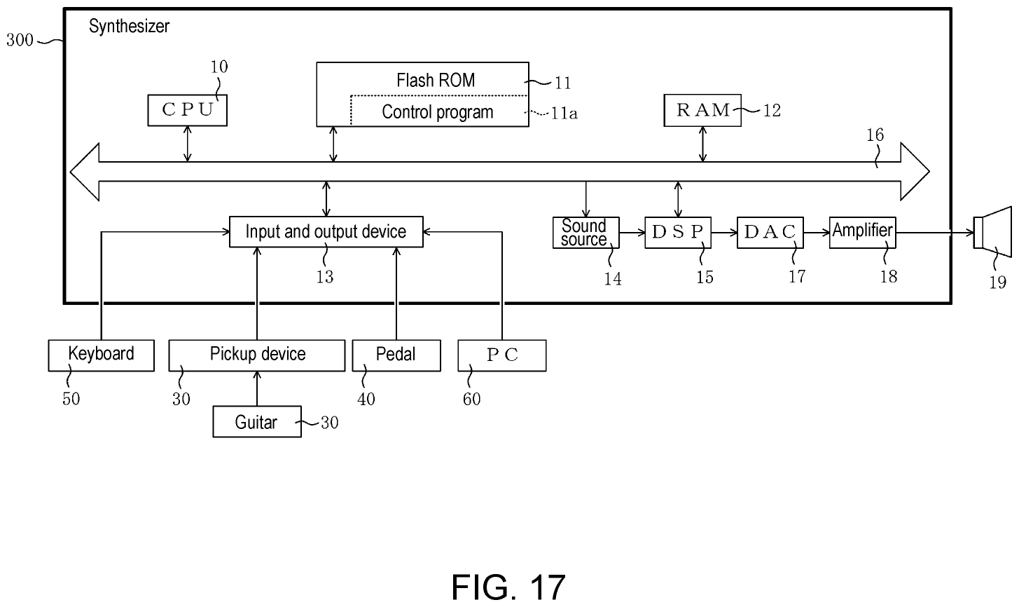

Next, a synthesizer 300 of a third embodiment will be described with reference to FIGS. 17 to 20. The synthesizers 1 and 200 of the first and second embodiments described above have generated tones corresponding only to the MIDI message MM based on the performance input from the guitar G. On the other hand, the synthesizer 200 of the third embodiment is configured so that the tone can be generated on the basis of input from not only the guitar G but also a keyboard 50 or a PC 60. The same configurations as those of the first and second embodiments described above are denoted by the same reference numerals, and detailed description thereof will be omitted.

FIG. 17 is a block diagram illustrating an electrical configuration of a synthesizer 300 according to the third embodiment. The keyboard 50 and the PC 60 are connected to the input and output device 13 of the synthesizer 300, in addition to the pickup device 30 and the pedal 40.

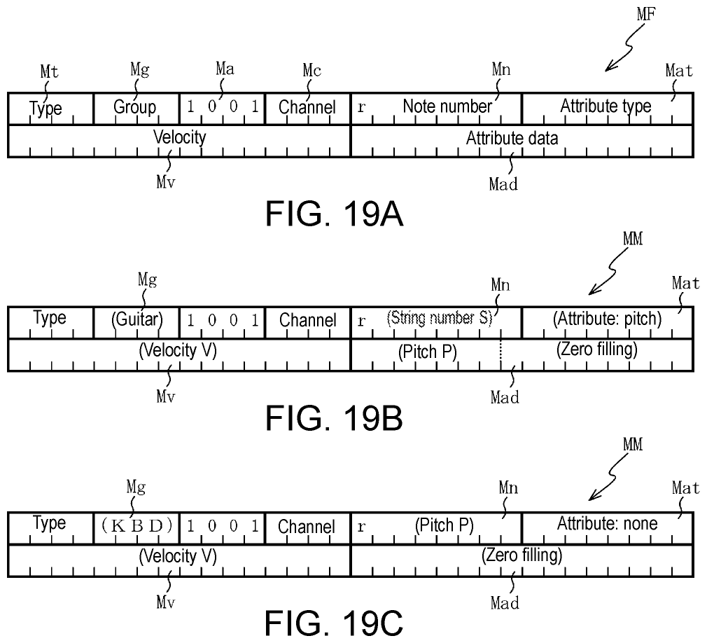

The keyboard 50 is an input device having a keyboard. The keyboard 50 creates a MIDI message MM based on an operation of the user H with respect to the keyboard, and inputs the MIDI message MM to the synthesizer 300 via the input and output device 13. Details of the MIDI message MM created with the keyboard 50 will be described below with reference to FIG. 19. The PC 60 is an information processing device (computer) that inputs the MIDI message MM to the synthesizer 300.

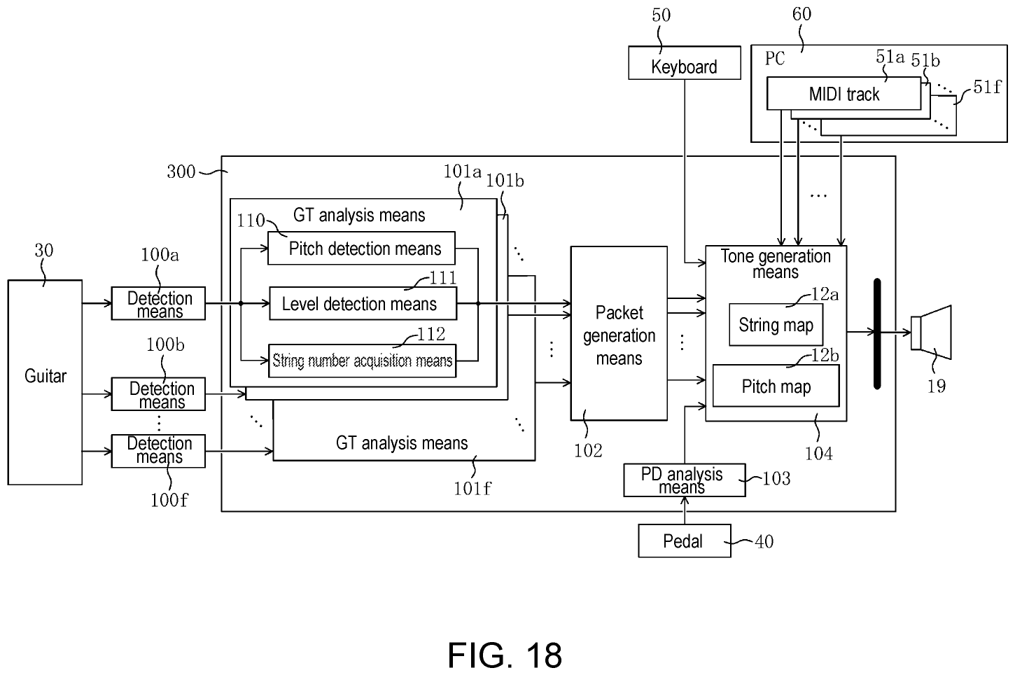

FIG. 18 is a functional block diagram of the synthesizer 300 according to the third embodiment. The keyboard 50 and the PC 60 are connected to the tone generation means 104 in the synthesizer 300, in addition to the packet generation means 102 and the PD analysis means 103. From the keyboard 50, the MIDI message MM based on the operation of the user H with respect to the keyboard is input to the tone generation means 104.

In the PC 60, MIDI tracks 51a to 51f consisting of a series of a plurality of MIDI messages MM are stored, and managed by an application program (for example, digital audio workstation (DAW)) installed in the PC 60. The MIDI messages MM sequentially read from the MIDI tracks 51a to 51f in the PC 60 are input to the tone generation means 104 due to a playback instruction or the like from the application program of the PC 60. Since the MIDI message MM constituting the MIDI tracks 51a to 51f and an order thereof can be edited by the user H, the user H can create the MIDI tracks 51a to 51f for generation of a desired tone. The number of MIDI tracks stored in the PC 60 is not limited to the six MIDI tracks 51a to 51f, and may be smaller than six or greater than six.

Next, a structure of the MIDI message MM created with the keyboard 50 will be described with reference to FIG. 19. FIG. 19A is a diagram schematically illustrating a structure of the MIDI message MF, FIG. 19B is a diagram schematically illustrating a structure of the MIDI message MM based on the guitar G, and FIG. 19C is a diagram schematically illustrating a structure of the MIDI message MM based on the keyboard 50.

In the synthesizer 300, the same MIDI message MM illustrated in FIG. 19A as that in FIG. 2B is used as the format of the MIDI message MM. Further, the same MIDI message MF illustrated in FIG. 19B as that in FIG. 2C is used as the MIDI message MM based on the guitar G.

In the MIDI message MM based on the keyboard 50, as illustrated in FIG. 19C, information indicating “KBD” indicating being the keyboard 50 is stored in the group Mg, the pitch P based on an operated key of the keyboard 50 is stored in the note number Mn, and the velocity V based on the velocity at which the keyboard is operated is stored in the velocity Mv. Thus, since the pitch P is stored in the note number Mn instead of the attribute data Mad, “attribute: none” indicating that the attribute data Mad is not used is stored in the attribute type Mat.

That is, in the MIDI message MM based on the guitar G, the pitch P is stored in the attribute data Mad, whereas in the MIDI message MM based on the keyboard 50, the pitch P is stored in the note number Mn. A MIDI message MM in a format created by the packet generation means 102 in FIG. 19B may be set in the MIDI tracks 51a to 51f of the PC 60, a MIDI message MM in a format created by the keyboard 50 in FIG. 19C may be set, or the MIDI messages MM in these formats may be both set.

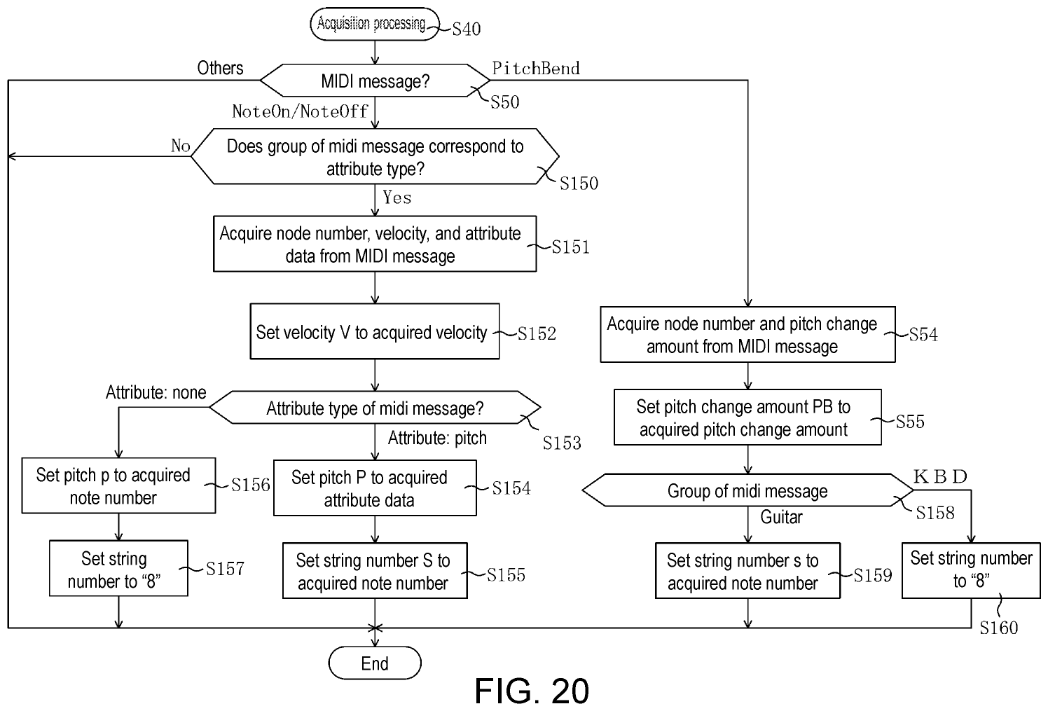

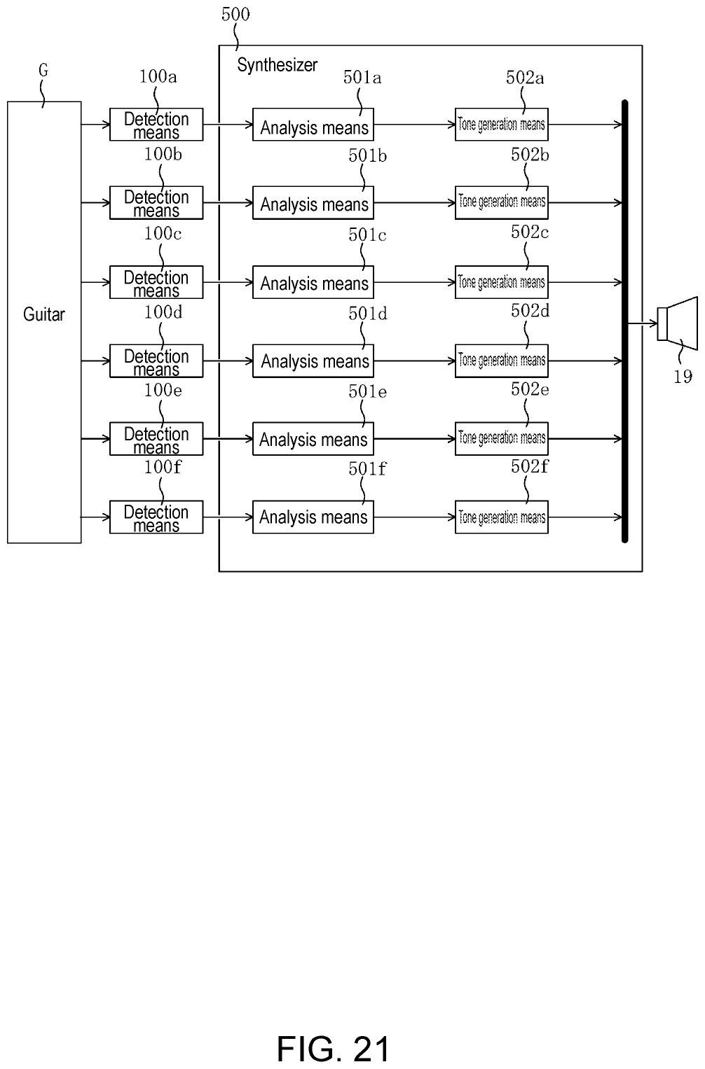

Next, the acquisition processing of S40 for acquiring the velocity V, pitch P, and string number S from each of the MIDI message MM in the format created by the packet generation means 102 and the MIDI message MM in the format created by the keyboard 50 will be described with reference to FIG. 20.

FIG. 20 is a flowchart of the acquisition processing (S40) of the third embodiment. In the acquisition processing of the third embodiment, in the processing of S50, when the MIDI message MM is note-on or note-off (S50: “NoteOn/NoteOff”), a confirmation is made as to whether or not a value of the group Mg of the MIDI message MM corresponds to a value of the attribute type Mat (S150). Specifically, when the value of the group Mg is “guitar” and the value of the attribute type Mat is “attribute: pitch”, or when the value of the group Mg is “KBD” and the value of the attribute type Mat is “attribute: none”, a determination is made that the value of the group Mg of the MIDI message MM corresponds to the value of the attribute type Mat.

In the processing of S150, when the value of the group Mg of the MIDI message MM corresponds to the value of the attribute type Mat (S150: Yes), the values are acquired from the area of each of the note number Mn, velocity Mv, and attribute data Mad of the input MIDI message MM as in the processing of S51 and S52 above (S151), and the value acquired from the velocity Mv is set to the velocity V (S152).

After the processing of S152, the value of the attribute type Mat of the input MIDI message MM is confirmed (S153). In the processing of S153, when the value of the attribute type Mat of the MIDI message MM is “attribute: pitch” (S153: “attribute: pitch”), that is, when the MIDI message is a MIDI message MM based on the guitar G, the pitch P is set to the value acquired from the attribute data Mad similarly to the processing of S53 and S56 (S154), and the string number S is set to the value acquired from the note number Mn (S155).

On the other hand, when the value of the attribute type Mat of the MIDI message MM is “attribute: none” in the processing of S153 (S153: “attribute: none”), that is, when the MIDI message is a MIDI message MM based on the keyboard 50, the pitch P is set to the value acquired from the note number Mn (S156), and the string number S is set to “8” (S157).

In the processing of S50, when the MIDI message MM is a pitch bend (S50: “PitchBend”), the value of the group Mg of the input MIDI message MM is confirmed after the processing of S54 and S55 described above (S158). In the processing of S158, when the value of the group Mg of the MIDI message MM is “guitar” (S158: “guitar”), the string number S is set to the value acquired from the note number Mn, similarly to the processing of S56 described above (S159). On the other hand, in the processing of S158, when the value of the group Mg of the MIDI message MM is “KBD” (S158: “KBD”), the string number S is set to “8” (S160).

In the processing of S157 and S160, the string number S is set to “8” for the MIDI message MM from the keyboard 50, making it possible for the tone generation means 104 to perform the same tone generation processing as that for the MIDI message MM created by the packet generation means 102 on the basis of the guitar G, even when the MIDI message MM from the keyboard 50 that does not consider strings as in the guitar G is used.

In the processing of S157 and S160, the value set for the string number S is not limited to “8”, and may be equal to or greater than “8” or equal to or smaller than “8”. In this case, in order to avoid duplication with the string number S of the guitar G that is connected at the same time, it is preferable for the value to be greater than a maximum string number S of the guitar G. On the other hand, in the case of the tone generation mode “string legato”, the string number S set in the processing of S157 and S160 is set to the same value as the string number S of the guitar G, making it possible to perform tone generation in an aspect that pitches are continuously connected from the performance of the guitar G to the performance of the keyboard 50.

Further, in the processing of S153, the value of the attribute type Mat of the MIDI message MM has been used to discriminate the MIDI message MM based on the keyboard 50 or the MIDI message MM based on the guitar G, but the disclosure is not limited thereto. For example, the value of the group Mg of the MIDI message MM may be used to discriminate the MIDI message MM based on the keyboard 50 or the MIDI message MM based on the guitar G, similarly to the processing of S158.

When the MIDI message MM is neither the note-on, the note-off, nor the pitch bend in the processing of S50 (S50: “Other”), the value of the group Mg of the MIDI message MM does not correspond to the value of the attribute type Mat in the processing of S150 (S150: No), or after the processing of S155, S157, S159, and S160, the acquisition processing ends.

As described above, in the synthesizer 300 of the third embodiment, the keyboard 50 and the PC 60 are connected in addition to the guitar G, and the MIDI message MM is also input from the keyboard 50 and the PC 60. Accordingly, since the synthesizer 300 can generate musical tones based on the MIDI messages MM from various input sources, it is possible to improve the usability of the synthesizer 300 for the user H.

Further, in the acquisition processing illustrated in FIG. 20, since the velocity V, pitch P, and string number S are acquired from the MIDI message MM based on the keyboard 50 and the MIDI message MM based on the guitar G, it is possible to process the two types of MIDI messages MM using the same tone generation means 104. Accordingly, since accurate tone generation and muting of musical tones can be realized without providing the tone generation means 104 for each type of input MIDI messages MM, that is, with one tone generation means 104, it is also possible to reduce the processing load required for the tone generation means 104 in the synthesizer 300 to which two types of MIDI messages MM are input.

Although the description has been made on the basis of the embodiments, it can be easily inferred that various improvements and changes can be made.

In the embodiment, the tone generation means 104 is configured with both the string map 12a and the pitch map 12b, but the disclosure is not limited thereto and the tone generation means 104 may be configured with either the string map 12a or the pitch map 12b. Further, the string map 12a and the pitch map 12b are not limited to being provided separately, but may be integrated into one data table. In this case, a count may be provided for each combination of the string number S and the pitch P.

In the embodiment, when the tone re-generation in the processing of S90 to S93 of the note-off processing in FIG. 8C is performed, the tone with the lowest string number S among the tones that have not been subjected to the note-off has been generated again, but the disclosure is not limited thereto. A tone with the highest string number S among the tones that have not been subjected to the note-off may be generated again or a tone with the string number S set by the user H in advance may be generated again.

The synthesizer 1 or 300 of the first or third embodiment is configured with one tone generation means 104, and the synthesizer 200 of the second embodiment is configured with two tone generation means including the tone generation means 104a and 104b, but the number of tone generation means is not limited thereto. Two or more tone generation means 104 may be provided in the synthesizer 1 or 300 of the first or third embodiment, and three or more tone generation means may be provided in the synthesizer 200 of the second embodiment.

The guitar G, the keyboard 50, and the PC 60 are connected to the synthesizer 300 in the third embodiment, but the disclosure is not limited thereto. Only the guitar G and the keyboard 50 may be connected to the synthesizer 300, only the guitar G and the PC 60 may be connected to the synthesizer 300, or only the keyboard 50 and the PC 60 may be connected to the synthesizer 300. Further, only the keyboard 50 may be connected to the synthesizer 300, or only the PC 60 may be connected to the synthesizer 300. Further, a device that inputs the MIDI message MM other than the keyboard 50 and the PC 60 may be connected to the synthesizer 300 and the MIDI message MM may be input from the device.

Further, the MIDI track may be stored in the flash ROM 11 of the synthesizer 300, the MIDI messages MM may be sequentially read from the MIDI track of the flash ROM 11, and musical tones may be generated on the basis of the MIDI messages MM.

In the embodiment, a configuration in which, when pitch bend such as the string pitch bend is applied, the pitch change amount PB is directly added to the target tone has been adopted, but the disclosure is not limited thereto. For example, a change amount twice the pitch change amount PB may be added to the pitch P for each string to which the pitch bend is applied, or a change amount 0.5 times the pitch change amount PB may be added to the pitch P.

In the second embodiment, two packet generation means 102a and 102b are provided for the two tone generation means 104a and 104b, but the disclosure is not limited thereto. For example, one packet generation means may be provided in common for the tone generation means 104a and 104b, or two or more packet generation means may be provided for one tone generation means.

In the embodiment, the guitar G has been used as the stringed instrument connected to the detection means 100a to 100f (the pickup device 30), but the disclosure is not limited thereto. For example, other stringed instruments such as a bass, violin, or cello may be used. Further, a keyboard instrument may be used instead of the stringed instrument. In this case, the detection means 100a to 100f may be connected to keys of the keyboard instrument, and the detection means 100a to 100f may convert information according to the performance of the corresponding keys into a state of vibration of strings, and detect the level L, the pitch P and the string number S according to the state of the vibration of the strings input by the GT analysis means 101a to 101f.

In the embodiment, the synthesizers 1 and 200 which are electronic musical instruments are illustrated as the control devices, but the disclosure is not limited thereto and may be applied to other control devices. Further, the control program 11a may be executable by an information processing device such as another personal computer or a mobile terminal.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A control device comprising:
an acquisition part configured to acquire performance information;
a tone generation control part configured to generate a musical tone based on the performance information acquired by the acquisition part;
a change amount acquisition part configured to acquire a pitch change amount that is a change amount by which a pitch is changed;
a changing string number acquisition part configured to acquire a string number of a string of a stringed instrument that is a pitch change target; and
a pitch changing part configured to change a pitch of the musical tone generated by the tone generation control part corresponding to the string number acquired by the changing string number acquisition part, on the basis of the pitch change amount acquired by the change amount acquisition part.

2. The control device according to claim 1, wherein the pitch changing part does not change pitches of musical tones that are not being generated.

3. The control device according to claim 1, further comprising:
an attenuated tone output part configured to output an attenuated tone, the attenuated tone being a tone in an aspect in which the musical tone being generated is attenuated, when note-off is designated for the musical tone being generated,
wherein the pitch changing part does not change pitches of the musical tone for which note-off is designated and the attenuated tone output by the attenuated tone output part.

4. The control device according to claim 1, comprising:
a tone color setting part configured to set a tone color to be generated according to the pitch,
wherein the pitch changing part changes the pitch of the musical tone according to the pitch change amount acquired by the change amount acquisition part, and changes the tone color of the musical tone to the tone color set by the tone color setting part according to the pitch of the musical tone.

5. The control device according to claim 4, wherein the pitch changing part stops the generation of the musical tone before changing the pitch and tone color and then starts the generation of the musical tone after changing the pitch and tone color when changing the pitch of the musical tone according to the pitch change amount acquired by the change amount acquisition part, and changing the tone color of the musical tone to the tone color set by the tone color setting part according to the pitch of the musical tone.

6. The control device according to claim 4,
wherein the acquisition part acquires performance information based on the stringed instrument, and
the tone color setting part sets the tone color to be generated according to a range of frets of the stringed instrument.

7. The control device according to claim 5,
wherein the acquisition part acquires performance information based on the stringed instrument, and
the tone color setting part sets the tone color to be generated according to a range of frets of the stringed instrument.

8. The control device according to claim 1, wherein the acquisition part acquires independent performance information for each string of the stringed instrument.

9. The control device according to claim 2, wherein the acquisition part acquires independent performance information for each string of the stringed instrument.

10. The control device according to claim 3, wherein the acquisition part acquires independent performance information for each string of the stringed instrument.

11. The control device according to claim 4, wherein the acquisition part acquires independent performance information for each string of the stringed instrument.

12. A musical tone generation method comprising:
an acquisition step of acquiring performance information;
a tone generation control step of generating a musical tone based on the performance information acquired in the acquisition step;
a change amount acquisition step of acquiring a pitch change amount that is a change amount by which a pitch is changed;
a changing string number acquisition step of acquiring a string number of a string of a stringed instrument that is a pitch change target; and
a pitch changing step of changing a pitch of the musical tone generated in the tone generation control step corresponding to the string acquired in the changing string number acquisition step, on the basis of the pitch change amount acquired in the change amount acquisition step.

13. The musical tone generation method according to claim 12, wherein the pitch changing step includes not changing pitches of musical tones that are not being generated.

14. The musical tone generation method according to claim 12, comprising:
an attenuated tone output step of outputting an attenuated tone, the attenuated tone being a tone in an aspect in which the musical tone being generated is attenuated, when note-off is designated for the musical tone being generated,
wherein the pitch changing step includes not changing pitches of the musical tone for which the note-off is designated and the attenuated tone output in the attenuated tone output step.

15. The musical tone generation method according to claim 12, comprising:
a tone color setting step of setting a tone color to be generated according to the pitch,
wherein the pitch changing step includes changing the pitch of the musical tone according to the pitch change amount acquired in the change amount acquisition step, and changing the tone color of the musical tone to the tone color set in the tone color setting step according to the pitch of the musical tone.

16. The musical tone generation method according to claim 15, wherein the pitch changing step includes stopping the generation of the musical tone before changing the pitch and tone color and then starting the generation of the musical tone after changing the pitch and tone color when changing the pitch of the musical tone according to the pitch change amount acquired in the change amount acquisition step, and changing the tone color of the musical tone to the tone color set in the tone color setting step according to the pitch of the musical tone.

17. A computer-readable recording medium having a musical tone generation program for causing a computer to execute musical tone generation processing recorded thereon, the musical tone generation program causing the computer to execute:
an acquisition step of acquiring performance information;
a tone generation control step of generating a musical tone based on the performance information acquired in the acquisition step;
a change amount acquisition step of acquiring a pitch change amount that is a change amount by which a pitch is changed;
a changing string number acquisition step of acquiring a string number of a string of a stringed instrument that is a pitch change target; and
a pitch changing step of changing a pitch of the musical tone generated in the tone generation control step corresponding to the string acquired in the changing string number acquisition step, on the basis of the pitch change amount acquired in the change amount acquisition step.

18. The computer-readable recording medium having a musical tone generation program recorded thereon according to claim 17, wherein the pitch changing step includes not changing pitches of musical tones that are not being generated.

19. The computer-readable recording medium having a musical tone generation program recorded thereon according to claim 17, comprising:
an attenuated tone output step of outputting an attenuated tone, the attenuated tone being a tone in an aspect in which the musical tone being generated is attenuated, when note-off is designated for the musical tone being generated,
wherein the pitch changing step includes not changing pitches of the musical tone for which the note-off is designated and the attenuated tone output in the attenuated tone output step.

20. The computer-readable recording medium having a musical tone generation program recorded thereon according to claim 17, comprising:
a tone color setting step of setting a tone color to be generated according to the pitch,
wherein the pitch changing step includes changing the pitch of the musical tone according to the pitch change amount acquired in the change amount acquisition step, and changing the tone color of the musical tone to the tone color set in the tone color setting step according to the pitch of the musical tone.
